(19) United States
(12) Patent Application Publication
(10) Pub. No.: US 2003/0020753 A1
(43) Pub. Date: Jan. 30, 2003

(54) Product cost control graphical user interface

(76) Inventors: Asa Kling, Molndal (SE); Bjorn Svensson, Molnlycke (SE)

Correspondence Address: BIRCH STEWART KOLASCH & BIRCH, PO BOX 747, FALLS CHURCH, VA, 22040-0747, US

(21) Appl. No.: 09/911,733

(22) Filed: Jul. 25, 2001

(51) Int. Cl. G09G 5/00

(52) U.S. Cl. 345/764

(57) ABSTRACT

Disclosed is a graphical user interface viewable over the World Wide Web. The graphical user interface allows a user to display in report format product sue/cost over selectable periods, in varying detail and in different currencies. The use of the grafical user interface results in a cost savings for both the consumer and the manufacturer.

### BACKGROUND OF THE INVENTION

1. Field of the Invention

The present invention relates to user interfaces for displaying computer storage database information, and more particularly, to graphical user interfaces providing computer stored database information relating to incontinence products used by specific institutions or groups of institutions.

2. Related Art

Until recently, products were tracked and reordered using conventional paper based methods. That is, product consumption and reorders were tracked using conventional mail or facsimile communication between the consumer and the manufacturer. This type of product tracking proved time consuming.

Currently, information related to consumed products is either maintained as written media, or stored and tracked in databases in volatile and/or non-volatile computer memory. Such database data relating to consumed products is often stored in a database at a consumer's side and in a database at a manufacturer's side. Using the data stored in the databases, both the consumer and the manufacturer are capable of generating reports regarding the total consumption of a specific product or plurality of products.

Information concerning consumption of incontinence products is currently stored in databases as described in the previous paragraph. Distinct and separate databases at the consumer and manufacturer locations are required in order to allow each party the opportunity to specifically and accurately track consumption of incontinence products. However, because the manufacturer and consumer databases are not connected, similar information must be stored in each of the database systems. This creates redundancies. Moreover, in a closed system where the manufacturer and consumer each have autonomous databases, statistical information relating to incontinence products, that may lead to a cost benefit for both the manufacturer and consumer, may be unavailable to the involved parties. Therefore, storing the redundant information at a central location that is accessible by both the manufacturer and consumer would be a significant cost saving for both parties.

Accordingly, it would be desirable to provide a graphical user interface (GUI) that summarizes consumed incontinence product information in a simple, easy to understand and user-friendly format. Moreover, it would be desirable to allow a consumer to review consumed incontinence product information relating to specific institutions owned or affiliated with the customer. It would be further desirable to provide incontinence product information to consumers and the manufacturer via a World Wide Web secure connection.

### SUMMARY OF THE INVENTION

In accordance with the above-identified disadvantages of conventional database systems, it is an object of the present invention to provide a manufacturer generated GUI which summarizes, in an easy and user friendly format, specific information related to incontinence products used by a customer.

It is further an object of the present invention to provide a GUI illustrating a summary report of specific incontinence products relating to a specific consumer institution.

Still further, it is an object of the present invention to provide a GUI which includes a detailed report of particular incontinence products used by a consumer institution.

It is yet another object of the present invention to provide a GUI including a ward report outlining incontinence products consumed by each ward in the consumer institution.

It is yet another object of the present invention to provide accessibility to various institutions owned or affiliated with a incontinence product consumer.

Another object of the present invention is to provide GUI reports to an incontinence product consumer definable using varying time frames and using different currencies.

It is yet another object of the present invention to allow incontinence consumers to group specific affiliated and/or owned institutions into predetermined groups such that GUI reports may be generated therefor.

It is yet another object of the present invention to provide summary, detailed or institutional reports relating to consumer institutions grouped in predetermined consumer identified groups.

It is yet another object of the present invention to provide a GUI system to assist in controlling costs associated with incontinence product management.

It is yet another object of the present invention to provide a GUI system to assist incontinence consumers with information useful in budgetary control.

It is further an object of the present invention to provide a GUI system that improves incontinence care.

Another object of the present invention is to provide institutional incontinence product use and care information that relates to various levels within the given institution.

Further, it is an object of the present invention to provide a GUI system that improves care for patient's requiring incontinence care.

In order to achieve the above objects of the present invention, and other objects, there is provided a data displaying interface, the interface comprising a first page comprising a field for selecting a desired institution, a field for selecting a desired period, and a button for displaying one of a plurality of reports containing associated information pertaining to a selected institution and a selected period.

Moreover, in order to achieve the objects of the present invention, and other objects, there is provided a method for displaying data, the method comprising the steps of generating a first graphical user interface having a first user selectable field pertaining to specific institutions, a second user selectable field pertaining to specific time periods, means for selecting a number of periods, means for selecting a currency type, and a button, and generating a second graphical user interface upon actuation of the button, the second graphical user interface being a report chosen from a plurality of predefined reports, wherein the report contains information relating to a selected institution and a specific time period.

Finally, in order to achieve the above objects of the present invention, and other objects, there is provided a method for providing institutional specific information, the method comprising the steps of providing a graphical user interface accessible using required login information, generating one of a plurality of reports based upon user selected institutional information and user selected periods of time, and displaying on any one of the plurality of reports specific information relating to incontinence products used in the user selected institutional information and during the user selected periods of time.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart illustrating responses to selectable items on an Institution GUI;

FIG. 2 is a flow chart illustrating a process in response to a selection from the Institution GUI;

FIG. 3 is a flow chart illustrating responses to selectable items on a Summary Report GUI;

FIG. 4 is a flow chart illustrating responses to selectable items on a Detail Report GUI;

FIG. 5 illustrates a flow chart of selectable processes from a Ward Report GUI;

FIG. 6 illustrates a flow chart of selectable processes from a Summary Ward Report GUI;

FIG. 7 illustrates a flow chart of selectable processes from a Detail Ward Report GUI;

FIG. 8 illustrates a flow chart of processes selectable from a Group GUI;

FIG. 9 illustrates a flow chart of processes selectable after selecting a Maintained Group button on the Group GUI;

FIG. 10 is a flow chart illustrating a process branching from the flow chart shown in FIG. 9;

FIG. 11 is a flow chart illustrating a process branching from the flow chart shown in FIG. 8;

FIG. 12 is a flow chart illustrating selectable choices on the Detail Report GUI;

FIG. 13 is a flow chart illustrating selectable choices on a Inst Report GUI;

FIG. 14 is flow chart box representative of the Data Entry GUI;

FIG. 15 illustrates an Institution GUI;

FIG. 16 illustrates a Summary Report GUI;

FIG. 17 illustrates a superimposed window over the Summary Report GUI illustrated in FIG. 16;

FIG. 18 illustrates a superimposed window over the Summary Report GUI illustrated in FIG. 16;

FIG. 19 illustrates a Detail Report GUI;

FIG. 20 illustrates a superimposed graph window assessable from the Detail Report illustrated in FIG. 19;

FIG. 21 illustrates a Ward Report GUI;

FIG. 22 illustrates a Summary Ward Report GUI;

FIG. 23 illustrates a Detail Ward Report GUI;

FIG. 24 illustrates a superimposed graph window assessable from the Detail Ward Report GUI illustrated in FIG. 23;

FIG. 25 illustrates a Group GUI according to the present invention;

FIG. 26 illustrates a Maintained Group window;

FIG. 27 illustrates a Create Group window;

FIG. 28 illustrates a Change Group window;

FIG. 29 illustrates a Delete Group window;

FIG. 30 illustrates a Summary Group Report GUI;

FIG. 31 illustrates a superimposed information window relating to the Group GUI illustrated in FIG. 30;

FIG. 32 illustrates a superimposed window that may be accessed using an Information icon illustrated in FIG. 30;

FIG. 33 illustrates a Detail Group Report GUI;

FIG. 34 illustrates an Inst Group Report; and

FIG. 35 illustrates the Detail Report GUI as a superimposed window.

### DETAILED DESCRIPTION OF THE PREFERRED EMBODIMENTS

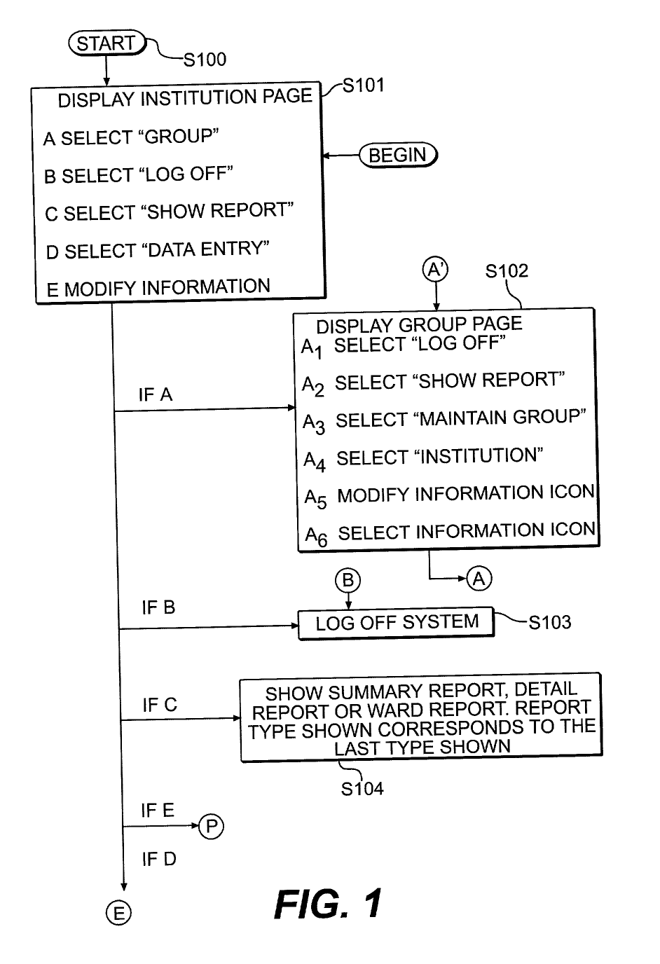

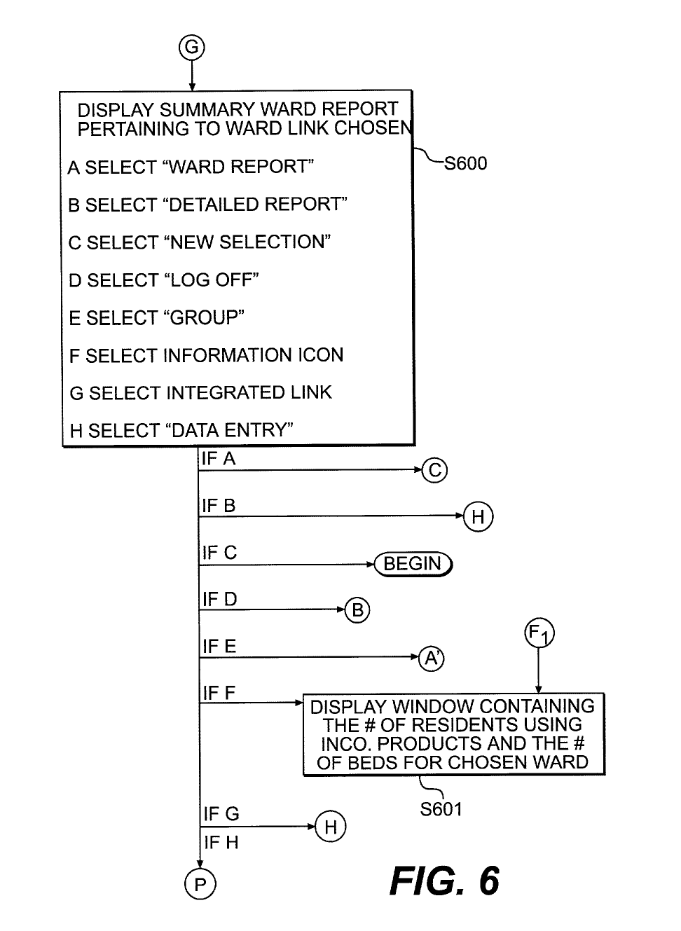

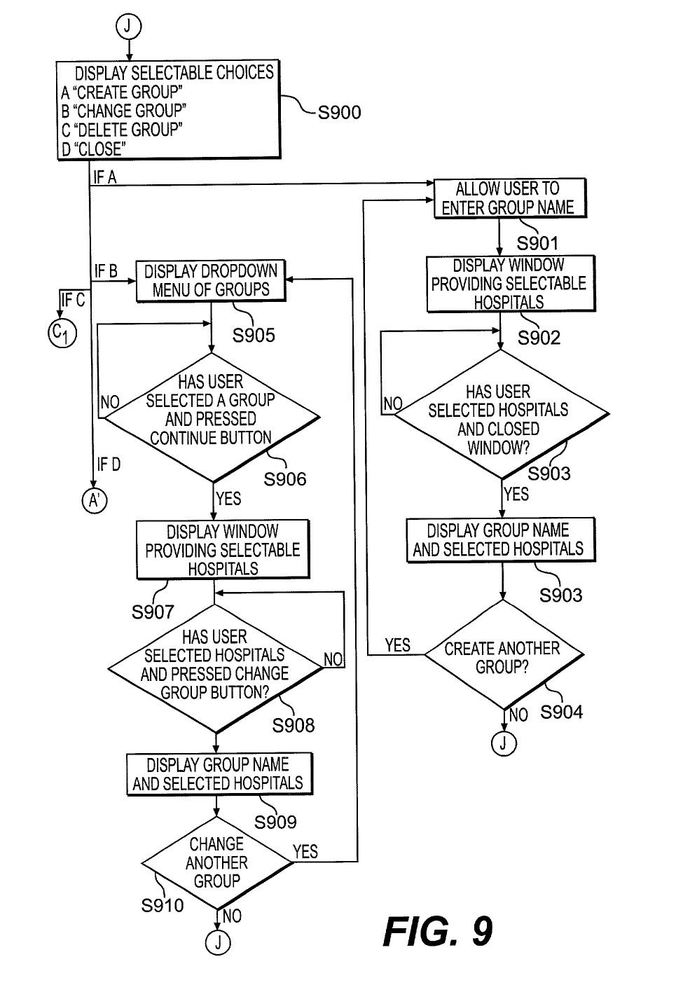

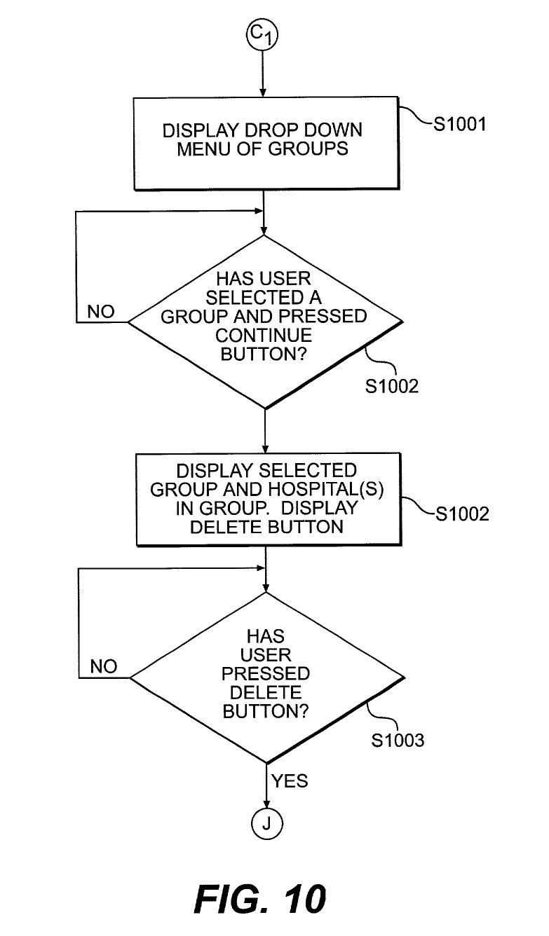

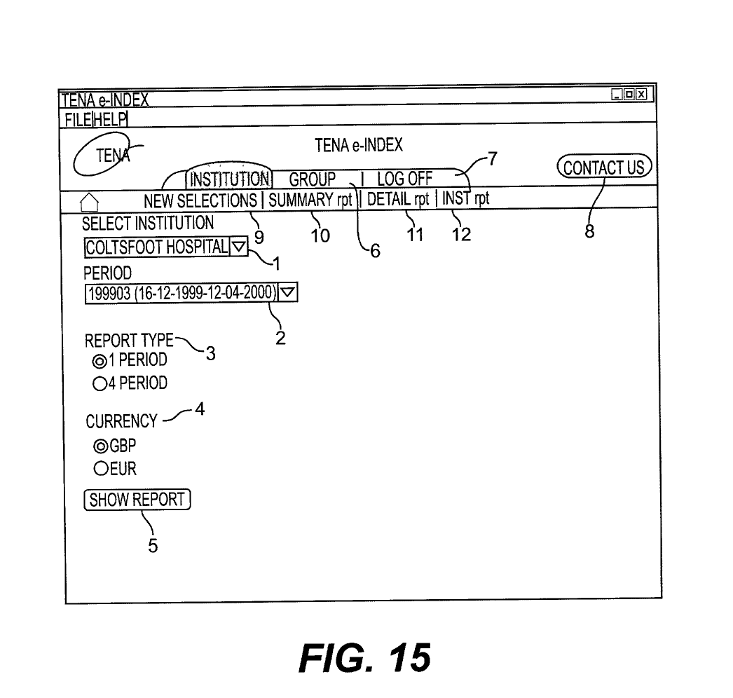

FIGS. 1-14 are flow charts illustrating the operational characteristics of the GUI environment illustrated in FIGS. 15-35. Specifics of the GUI environment as shown in FIGS. 15-35 will be described after the description of the flow charts illustrated in FIGS. 1-14.

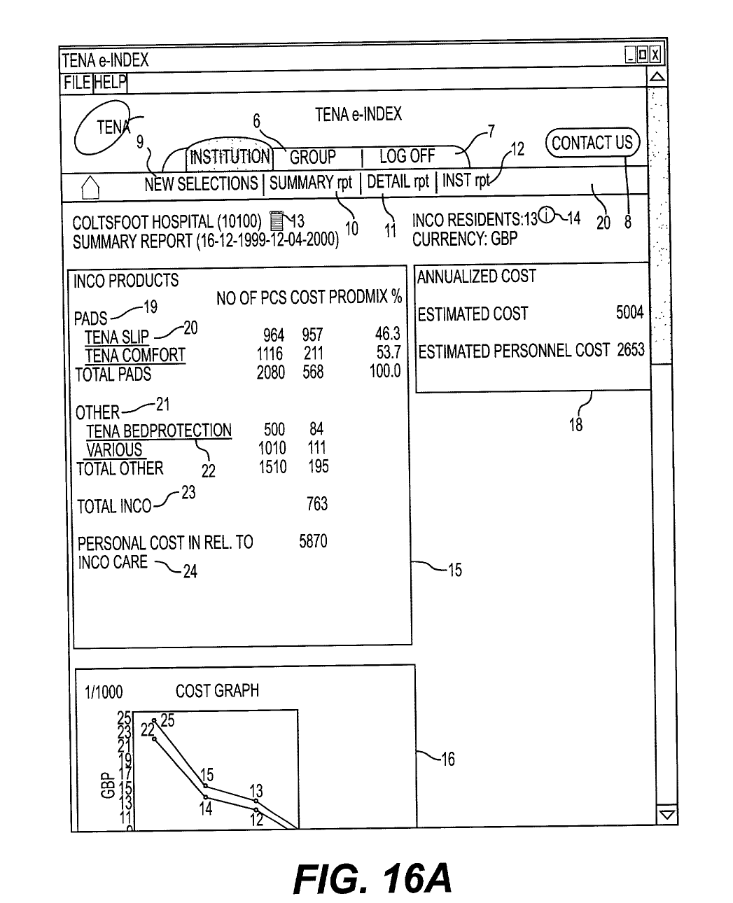

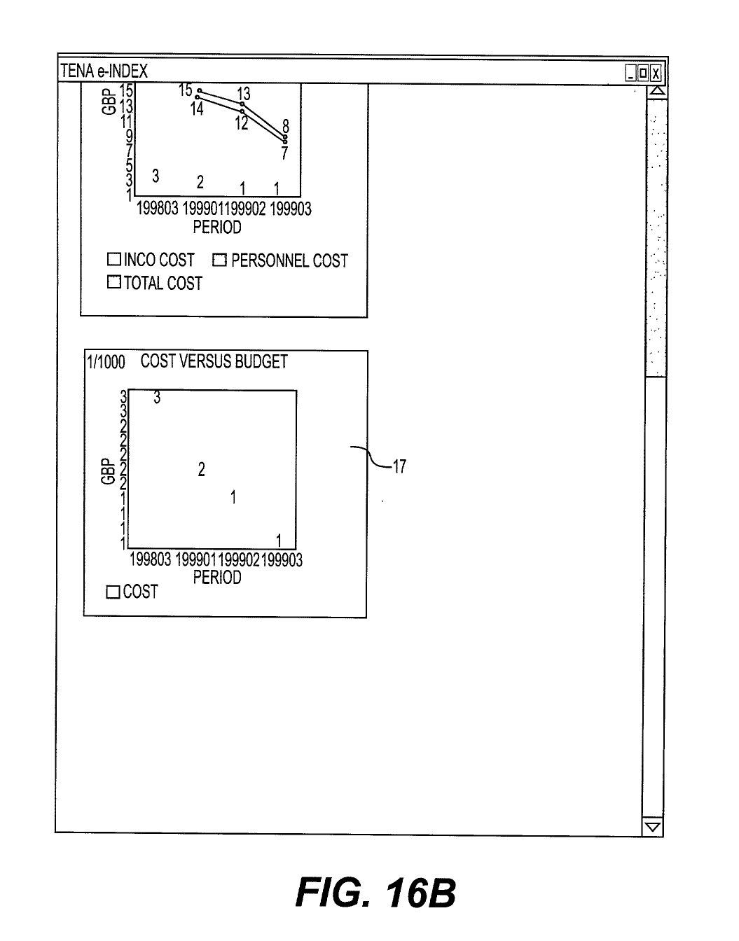

FIG. 1 is a flow chart illustrating the processes that occur upon selection of certain selectable objects on an Institution GUI according to the present invention. The actual screen of the Institution GUI is illustrated in FIG. 16.

After a user has logged on (S100), the Institution GUI is displayed (S101). The Institution GUI displays various selectable items. The user may select a specific institution, a particular period, define the type of report type and currency, and/or immediately show a report. The user may also select to proceed to a Group GUI or Data Entry GUI if desired. The specifics of the Group GUI will be discussed hereinafter. However, Data Entry functionality will not be discussed in detail. The user may also choose to log off or display a window containing contact information.

Once the user has modified the information shown on the Institution GUI, or the information was correct when the GUI environment was first initialized, the Show Report button may be actuated. The actuation of the Show Report button will display a Summary Report GUI, Detail Report GUI or Ward Report GUI. Displaying one of these reports depends upon the last type of report displayed. Specifically, if the user previously displayed the Detail Report GUI and then returned to the Institution GUI (S101), then upon subsequent actuation of the Show Report button, the Detailed Report GUI will once again be displayed. However, this only occurs if the user is currently in the same session when the Detailed Report GUI was displayed. In other words, once the user logs off, the GUI environment returns to its default settings. That is, after login and possible modification of the information on the Institution GUI, pressing the Show Report button will display the default report, which is the Summary Report GUI.

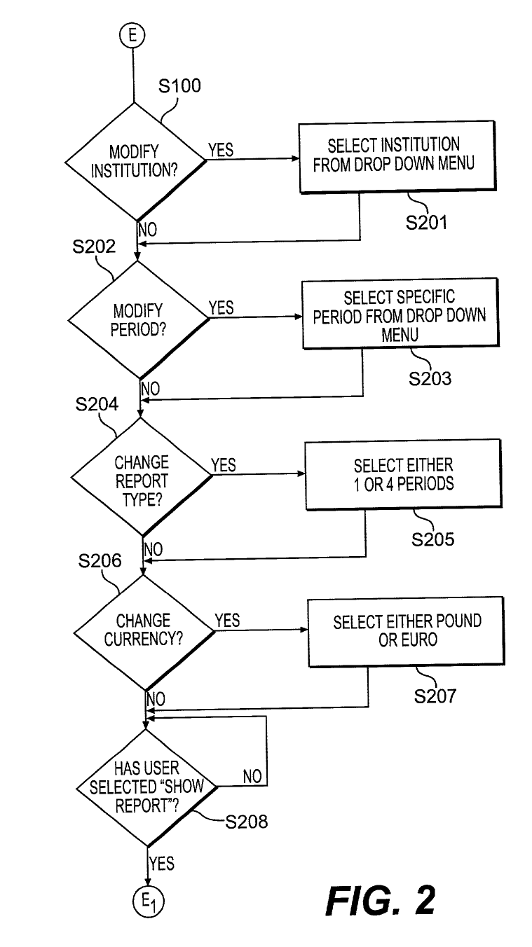

If the user chooses to modify the information of the Institution GUI (S101), then the process illustrated in FIG. 2 is followed. In particular, if the user desires to modify the institution (S200), the user may select a drop down menu and choose from various hospitals listed thereon (S201). Then, if the period is to be modified (S202), the user selects a period drop down menu to access the various periods contained therein (S203). If the report type is to be changed (S204), the user selects the choice between 1 or 4 periods for display on a report (S205). That is, on each of the Summary Report GUI, Detail report GUI and Ward Report GUI, information pertaining to one (1) or four (4) periods, depending on what the user selects, will be displayed. According to the present invention, one period is defined by an alphanumeric designation and spans approximately a four-month timeframe. If the user selects four periods the GUI environment automatically selects three (3) earlier periods for display with the user selected period.

The user may also decide to change the type of currency displayed on the reports (S206). The Institutional GUI is set up to accept either a selection between Pounds or Euros (S207), but other currencies may be added if desired. This concept is fully embraced by the present invention. Once all of the desired parameters have been selected by the user, the user may select the Show Report button (S208) to display the Summary Report.

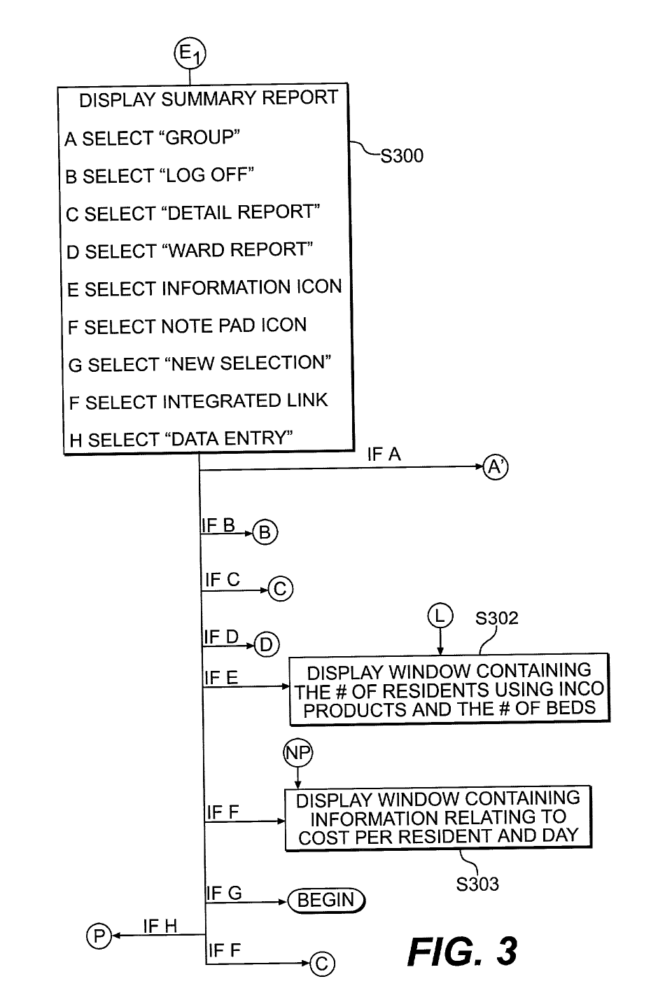

FIG. 3 illustrates a flow chart of the processes accessible from the Summary Report GUI. The user may select to display the Group GUI, log off, display the Detail Report GUI, display the Ward Report GUI, select an Information icon, select a Notepad icon, select New Selection, select an integrated link in the Summary Report GUI data, or select to display the Data Entry GUI (S300). If the user selects New Selection, then the Institution GUI is displayed. In particular, the New Selection link will return the user to the GUI discussed in relation to FIG. 1. If the user selects log off, then the current session is terminated. Specific links to the various reports allow the user to access the GUI's related to those reports. When the user selects the Information icon, a overlay window is superimposed on the Summary Report GUI, which contains information related to the number of residents using incontinent products and the number of beds used in the chosen institution (S302). Choosing the Notepad icon brings up an overlay window superimposed on the Summary Report GUI, which provides information relating to costs (S303). Selecting one of the integrated links on the Summary Report page will directly take the user to the Detail Report GUI.

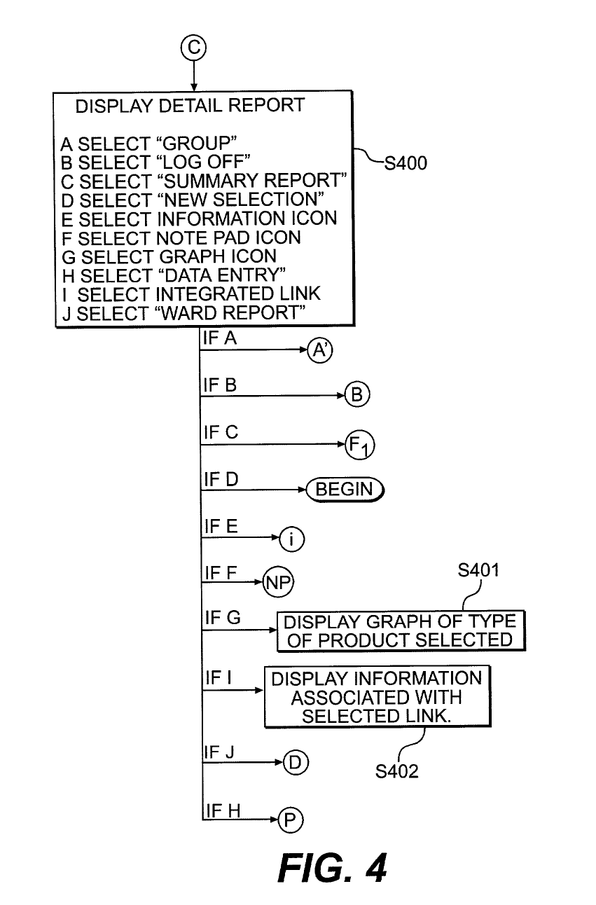

FIG. 4 illustrates a flow chart of the selectable options on the Detail Report GUI. Similar to the Summary Report and Institution GUIs, the Detail Report GUI contains selections to the Group Report GUI, log off, Summary Report GUI, New Selection, the Information icon, the Notepad icon, the Data Entry GUI and the Ward Report GUI. However, the Detail Report GUI also includes specific graphing icons related to various incontinent products used in the selected hospital. These graphing icons pictorially illustrate specific products used over the report period.

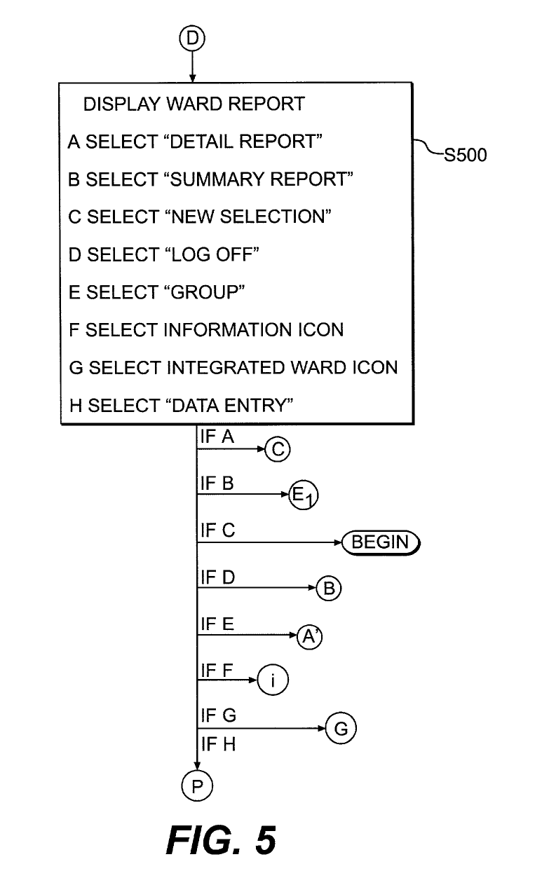

FIG. 5 illustrates the selectable items on the Ward Report GUI. On the Ward Report GUI, a user may select the Detail Report GUI, the Summary Report GUI, New Selection, log off, the Group GUI, the Information icon, or the Data Entry GUI (S500). These selections are also found on the previously discussed GUI's. In addition, the Ward Report GUI also includes integrated ward links pertaining to the number of wards in the selected hospital (S500). Upon selection of one of these integrated ward icons, a Summary Ward Report GUI is displayed. The Summary Ward Report GUI for the specific ward chosen provides various links to other GUI's. In particular, the Summary Ward Report GUI includes a link to New Selection, log off, the Group GUI, the Data Entry GUI, and the Ward Report GUI (S600). However, additional links to a Detail Ward Report GUI, an Information Ward icon, and integrated links, are also available on the Summary Ward Report GUI (S600). Selection of the Information Ward icon will display a window containing the number of residents using incontinence products and the number of beds used in the chosen ward. Selection of the Detail Ward report GUI will display detailed information of the information shown on the Summary Ward Report GUI. In addition, selection of the integrated links on the Summary Ward Report GUI will display the Detail Ward Report GUI for the user's convenience.

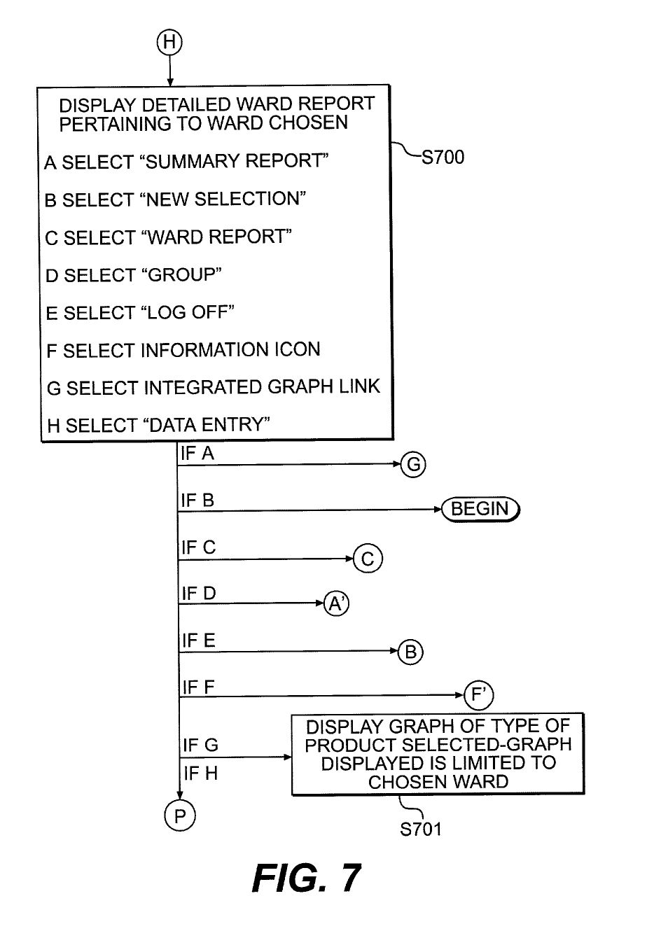

FIG. 7 illustrates the selectable items on the Detail Ward Report GUI. Similar to other report GUIs, the Detail Report GUI includes access to New Selection, the Ward Report GUI, the Group GUI, log off, the Information Ward icon, and the Data Entry GUI (S700). In addition, the Detail Ward report GUI also includes integrated graph links and a link to the Summary Ward Report GUI (S700). Selecting of one of the integrated graph links provides information pertaining to a specific incontinence products in use in the chosen ward (S701).

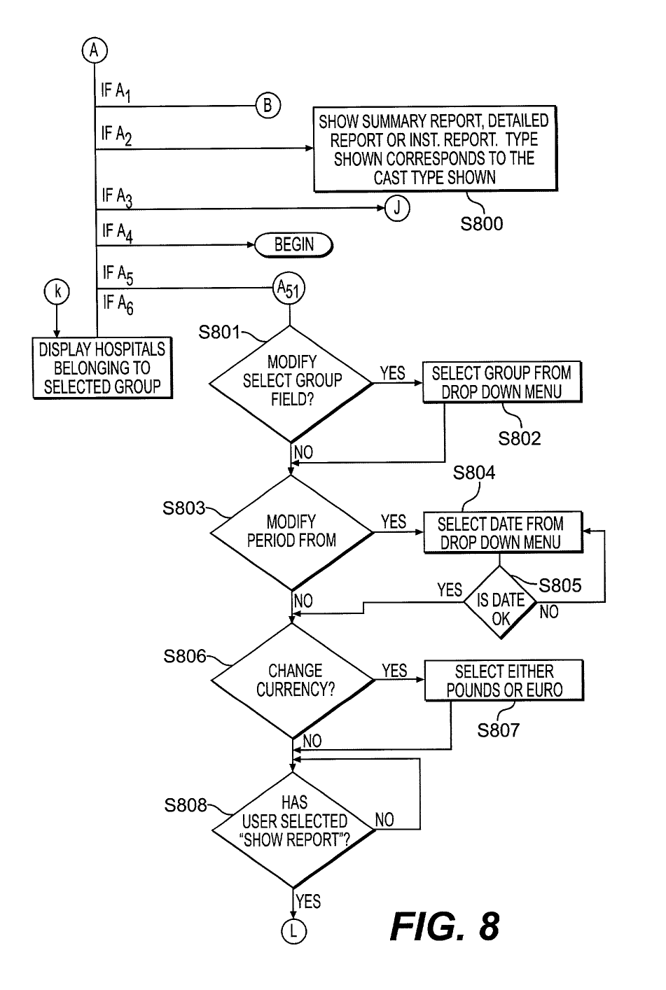

FIG. 8 illustrates selectable options from the Group GUI. As is indicated previously, the Group GUI is accessible from various other GUI's as desired by the user. FIG. 1 illustrates the selections available on the Group GUI (S102). Selecting log off will log the user off of the system. Selecting the Show Report button will immediately display the Summary Report GUI, the Detail Report GUI, or the Institution Report GUI. The specific report GUI shown corresponds to the last report type shown. However, if this is the first instantiation of selecting Show Report, the default Summary Report Group GUI will be displayed. The selection of the Maintain Group button on the Group GUI will display an overlay window that allows the user to modify groups. Details related to the modification of specific groups will be discussed hereinafter. Selecting the Institution link on the Group GUI will display the Institution GUI referenced in FIG. 1.

Modification of original information shown on the Group GUI is also possible. FIG. 8, shown following node A₅₁, illustrates the procedure to modify the original information shown on the Group GUI. If the user chooses to modify the Select Group field (S801), a predefined group from a list shown in a drop down menu may be selected (S802). The user may also modify the desired starting period (S803). To accomplish modification of the starting period, the user selects the start date of the period from the drop down menu (S804). A similar procedure is used to modify an end date. The user may also change the display currency (S806) from between Pounds and Euros (S807). Once the user has made any desired changes to the selectable parameters on the Group GUI, the Show Report button may be actuated (S808).

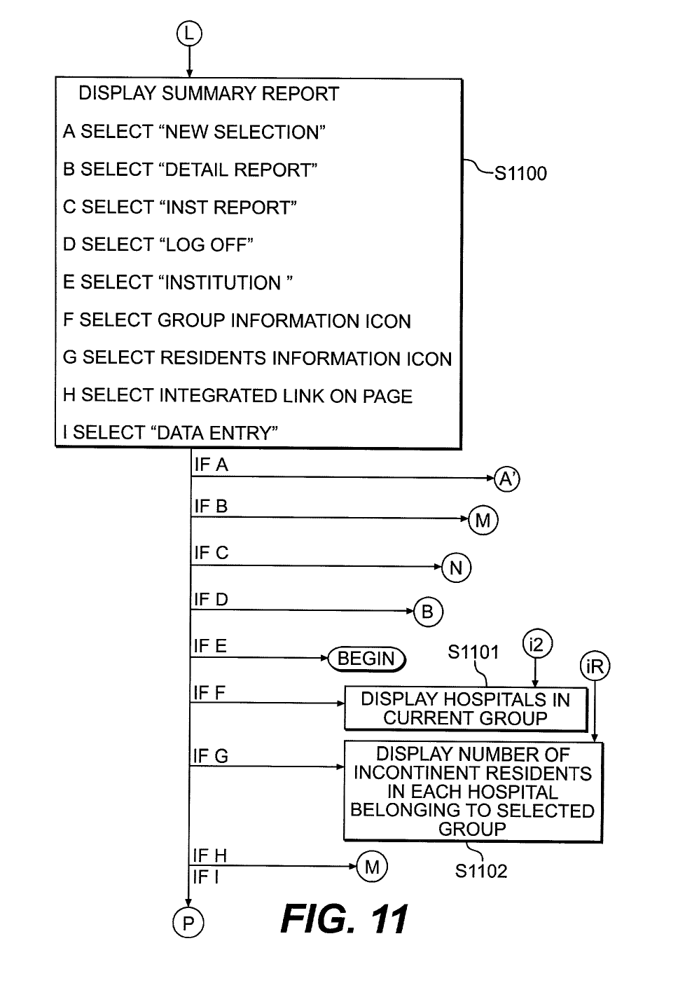

FIG. 11 illustrates the flow chart relating to the selections available on the Summary Group Report GUI. The Summary Group Report GUI includes selections to New Selection, the Detail Report GUI, log off, Institution GUI, a Group Information icon, a Residence Information icon, specific integrated links on the Summary Group report GUI, and a link to the Data Entry GUI (S1100). The links to New Selection, Detail Report GUI, log off, Institution, Data Entry GUI function in the same manner as previously discussed. For brevity, the discussion relating to the links will not be repeated.

Selection of the Group Information icon displays in a superimposed window the specific hospitals related to the selected group (SI 101). Selection of the Resident Information icon creates a superimposed window containing information related to the number of residents using incontinence products in each of the hospitals in the selected group (S1102). Selection of one of the integrated links on the Summary Group Report GUI will display the Detail Group Report GUI, which will be discussed hereinafter.

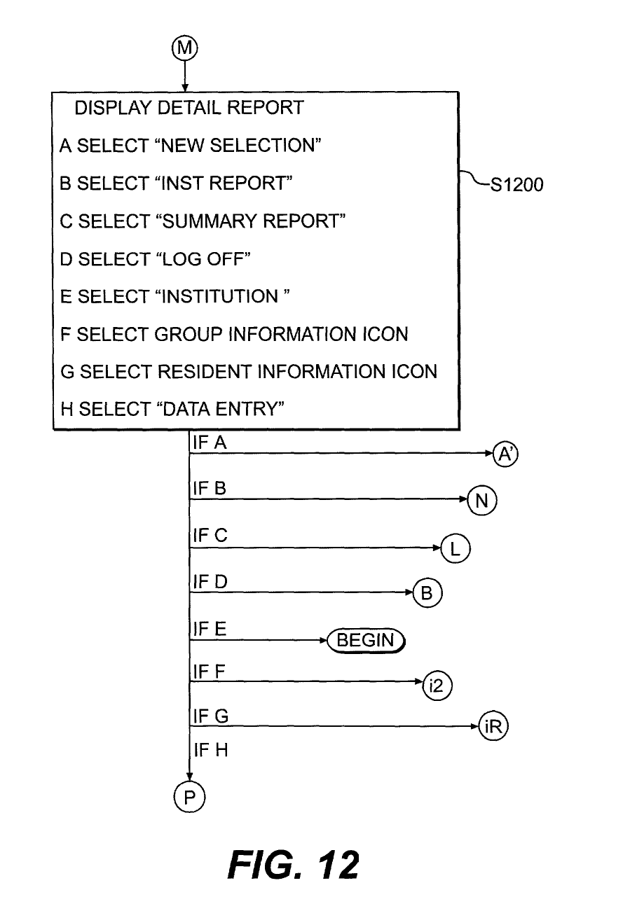

FIG. 12 illustrates a flow chart representative of the selections available on the Detail Group Report GUI. The Detail Group Report GUI provides selections to New Selection, the Institution GUI, the Summary Group Report GUI, log off, the Institution GUI, the Group Information icon, the Resident Information icon, and the Data Entry GUI (S1200). Each of these specific selections has been discussed previously and will not be repeated for brevity.

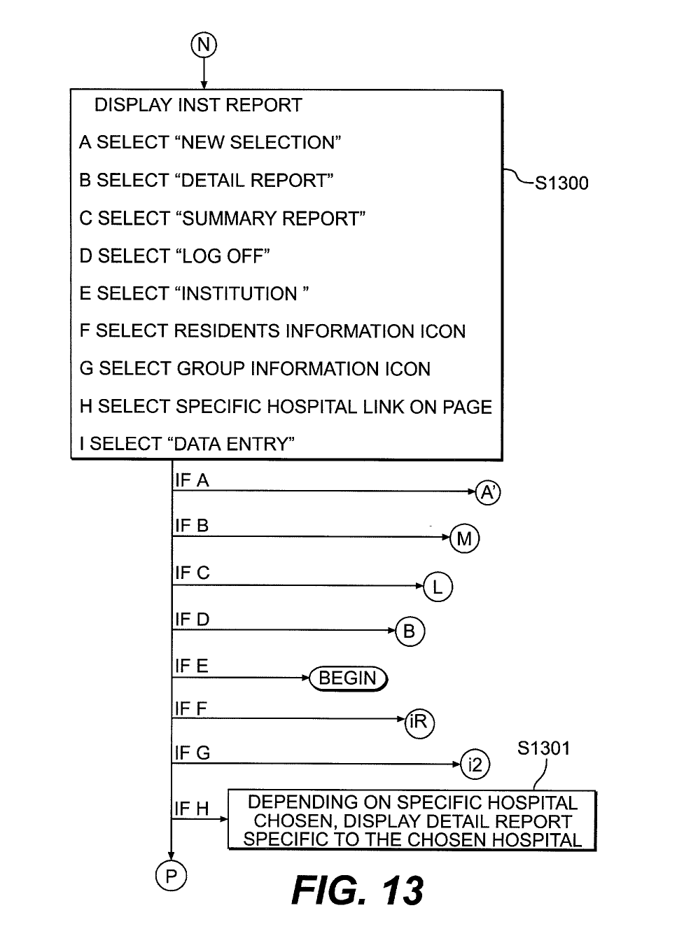

FIG. 13 is a flow chart illustrating selections available on the Inst Group Report GUI. The selections available on the Inst Group Report GUI are New Selection, the Detail Group Report GUI, the Summary Group Report GUI, log off, the Institution GUI, the Residence Information icon, the Group Information icon, specific links to hospitals in a chosen group, and a link to the Data Entry GUI. Selecting one of the specific links to the hospitals will, depending on the hospital link chosen, displays the Detail Report that relates to the chosen hospital. The specific report obtained for the chosen hospital is also available through the Institution GUI.

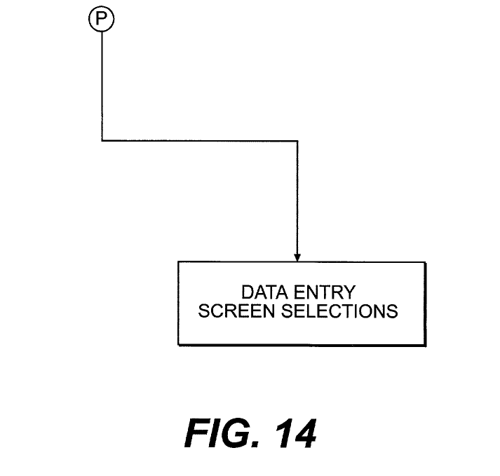

FIG. 14 is flow chart box representative of the Data Entry GUI. The specific details of the Data Entry GUI have not been discussed in detail herein.

The specific flow of each of the flow charts shown in FIGS. 1-14 has not been discussed in detail since it is self evident as to how the various GUI's are joined via selectable links on the various independent GUI's. Specific details of the specific flow of the various processes should be obtained through study of the included flow charts.

FIGS. 15-35 illustrate the various GUIs of the present invention. The GUIs illustrated in FIGS. 15-35 are operatively connected via the processes shown in FIGS. 1-14. The various links shown on the GUIs, and their operational characteristics, will be fully understood by the FIGS. 1-14 and the preceding discussion thereof.

FIG. 15 illustrates the Institution GUI, which is displayed after logging into the GUI environment, or by access from another link within the GUI environment. The Institution GUI includes several modifiable parts. The select institution drop down menu 1 allows a user to select between various hospitals within the GUI environment. The period drop down menu 2 allows the user to select between various delimited and predefined periods. Predefined periods may range from several days to several months. However, any conceivable period duration is fully embraced by the present invention. The institution GUI also includes a report type selectable field 3. Using the report type selectable field 3, the user may select between various numerical periods to be displayed on a report GUI. In addition, the Institution GUI includes a currency selectable field 4. Listed under the currency selectable field 4 are selections for Pounds and Euros. However, other currencies may be used if desired. The Institution GUI also includes links to a Group GUI 6 and a log off 7. Additionally, a superimposed window is obtainable using the Contact Us button 8. The superimposed window called up via the actuation of the Contact Us button 8 displays information pertaining to individuals directly associated with the GUI environment. The highlighted New Selection link 9 shows the current GUI active in the GUI environment. Pressing the Show Report button 5 will display either the Summary Report GUI 10, the Display Report GUI 11, or the Ward Report GUI 12.

FIG. 16 illustrates the Summary Report GUI 10. As indicated heretofore, the Summary Report GUI is accessible from various links within the GUI environment. The summary report GUI 10 includes generalized information related to the institution selected in the select institution drop down menu 1 (FIG. 15). From the Summary Report GUI 10 various other GUI reports may also be selected. For example, the Detailed Report GUI 11, the Ward Report GUI 12, or the New Selection link 9 may be selected. In particular, the inactive selections shown in a toolbar 20 are available for selection from the current GUI. This is true with each of the GUIs discussed. Similarly, the inactive tabs, part of the toolbar 20, are available for selection from the current GUI.

The summary report GUI 10 includes an incontinence products window 15, a cost graph window 16, a cost versus budget window 17, and an annualized cost window 18. The incontinence products window 15 includes a summary of products used within a specific selected institution. In this case, the Summary Report GUI 10 lists as the institution the “Coltsfoot hospital.” The information listed in the incontinence products window 15 includes pads 19, other 21, total incontinence 23, and personal cost in relation to incontinence care 24. On this report, specific sub products 20 are listed in the pads 19 product listing. Similarly, other specific sub products 22 are listed under the other header 21. The specific number of products used, and the total cost are also listed in the incontinence products window 15.

The cost graph window 16 illustrates graphically costs related to incontinence products, personal costs, and total costs. The vertical axis of the cost graph relates to a user chosen currency, while the horizontal axis relates to time. The cost versus budget window 17 illustrates graphically actual costs versus anticipated budgetary costs. The annualized cost window 18 provides annual cost information relating to products used and personnel.

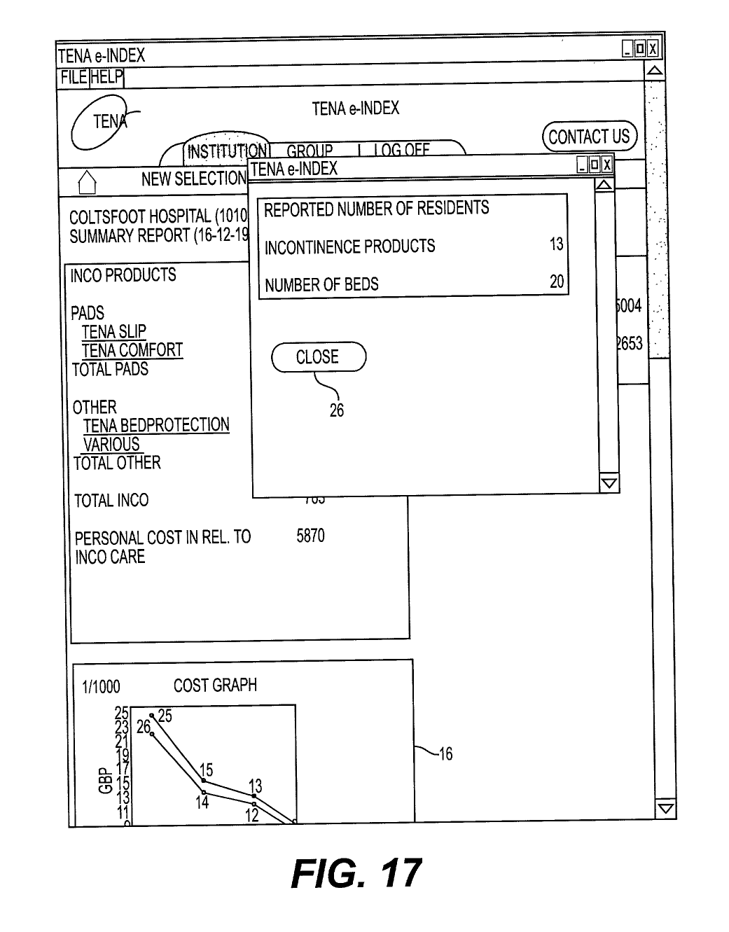

FIG. 17 illustrates a superimposed window over the Summary Report GUI. The superimposed window 25 is obtained when the incontinence residents information icon 14 is selected on the summary report GUI 10 (FIG. 16). Information in the superimposed window 25 relates a number of residents using incontinence products and the number of beds occupied by incontinent residents. The superimposed window 25 may be closed via a close button 26.

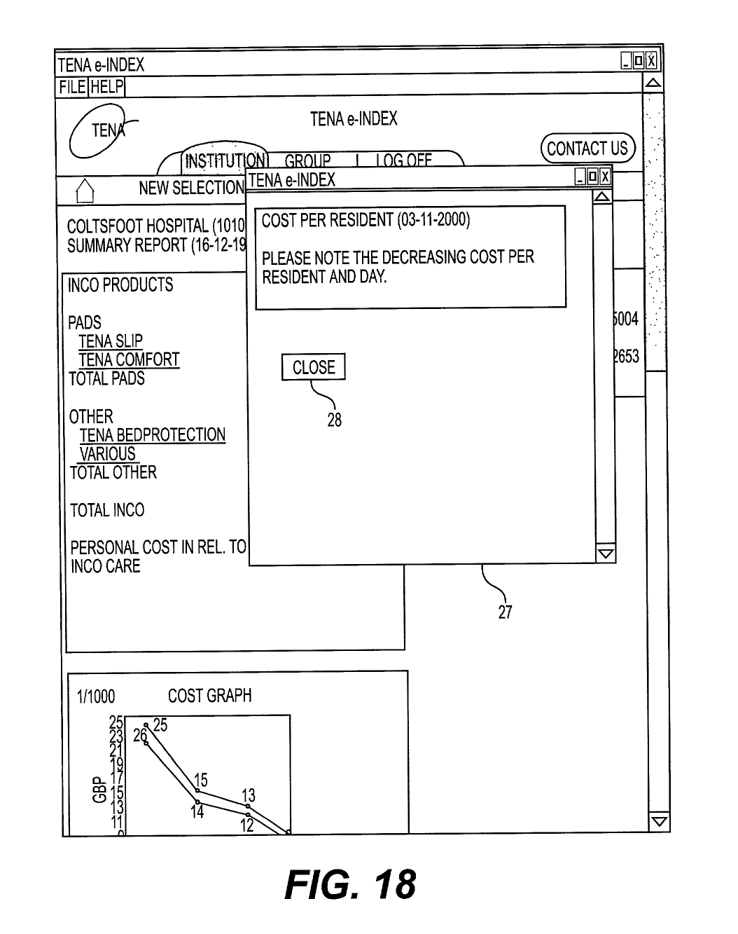

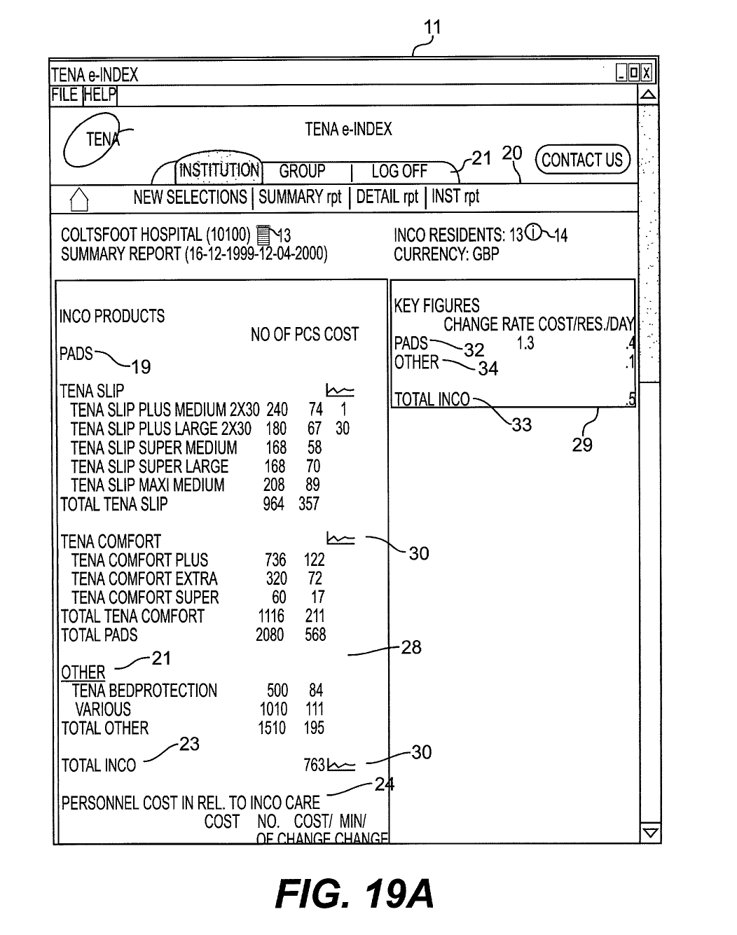

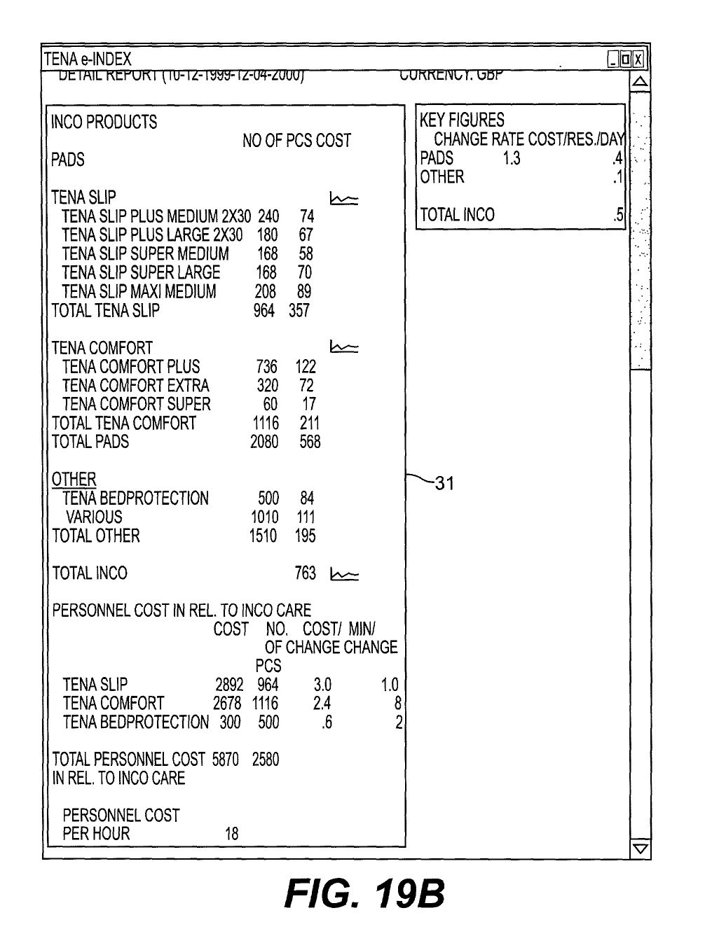

FIG. 19 illustrates a superimposed window over the Summary Report GUI 10. The superimposed window 27 shown in FIG. 18 is obtainable by pressing the Notepad icon 13 on the Summary Report GUI 10 (FIG. 16). A human administrator of the GUI environment enters information for display in the superimposed window 27. Such information pertains to cost trends discerned from analysis of the data displayed on the Summary Report GUI 10, or alternatively other GUIs of the GUI environment of the present invention. However, the information may also include administrator advice related to suggested future purchases of incontinence products based upon data collected by the manufacturer. The type of information displayable in the superimposed window 27 is limitless within the confines of analysis of data related to used/consumed incontinence products and the costs related thereto. The superimposed window 27 may be closed using the close button 28.

FIG. 19 illustrates the Detail Report GUI. The Detail Report GUI includes toolbar 20 with the tab box. For details of the toolbar 20, see the discussion relating to FIG. 16. The Detail Report GUI 11 also includes Notepad icon 13 and Informational icon 14. Two specific windows are included on the detail report GUI 11. Those windows are incontinence products window 28 and keyfigures window 29. The incontinence products window 28 includes specific information related to pads 19, other 21, total incontinence 23, and personal cost in relation to incontinence care 24. The incontinence products window 28 also includes a plurality of graph links 30. The key figures window 29 includes information relating to pads 32, other 34, and total incontinence 33.

The incontinence products window 28 is simply a more detailed version of the incontinence products window 15 illustrated in the Summary Report GUI 10. The graph links 30 allow the user the possibility of graphically illustrating information pertaining to specific products listed on the Detail Report GUI 11.

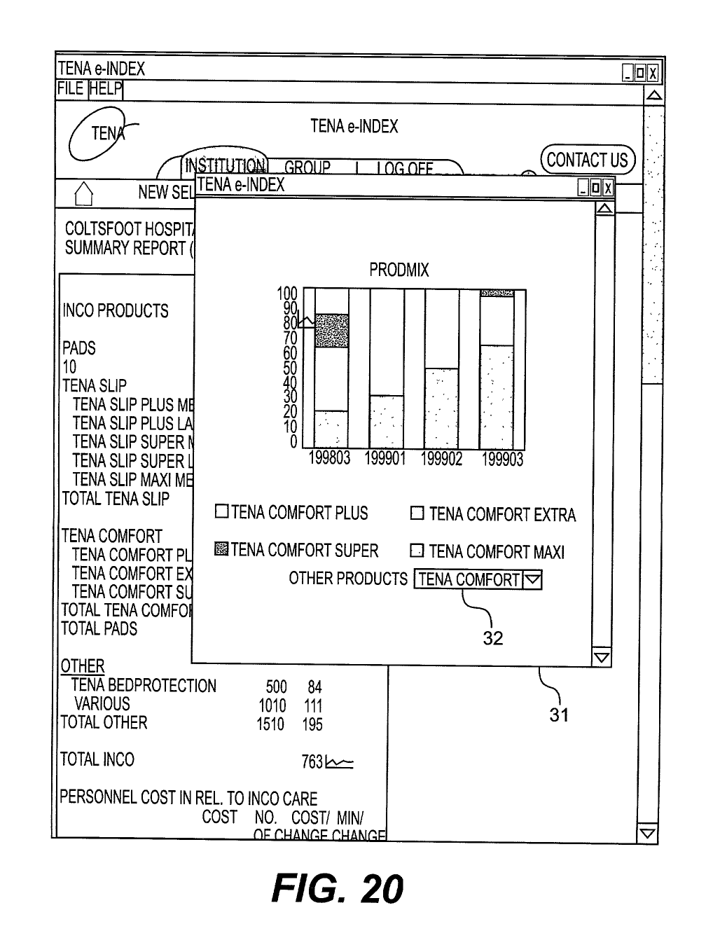

FIG. 20 illustrates a superimposed graph that is selectable from the Detail Report GUI, or one of the graph links 30. The graph 31 illustrates specific information relating to a product group illustrated in the incontinence products window 28. In this case, the superimposed window 31 is a bar graph illustrating product mixes of specific products. Graphs to other products may be selected via drop down menu 32. Similarly, other graphs to specific products may be selected using any one of the graph links 30 (FIG. 19).

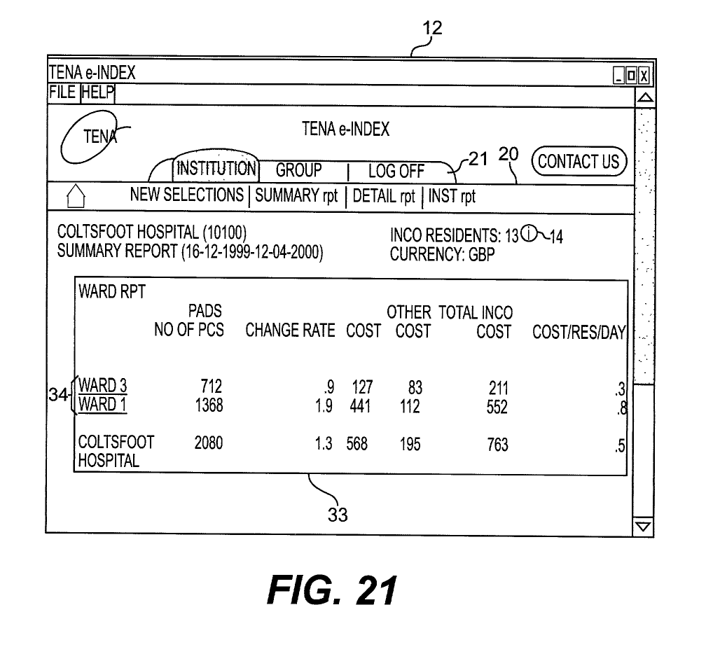

FIG. 21 illustrates a Ward Report GUI. The Ward Report GUI 12 includes the toolbar 20 and the tab box. Moreover, the Ward Report GUI 12 includes the incontinence residents information icon 14. Similar to the other GUI's discussed hereinabove, the Ward Report GUI 12 includes information pertaining to the selected institution, along with at least one specific window containing information. In the case of the Ward Report GUI 12, the window pertains to wards in the chosen institution. The wards of the institution are shown in ward report window 33.

The contents of the ward report window 33 includes information pertaining to an amount of pads and other products used in each ward, change rate, costs, other costs, total incontinence costs, and costs per residence on a daily basis. The ward report window 33 further includes links 34 to specific wards in the chosen institution. Choosing one of these links 34 will bring up a Detail Report GUI pertaining to the individual ward chosen.

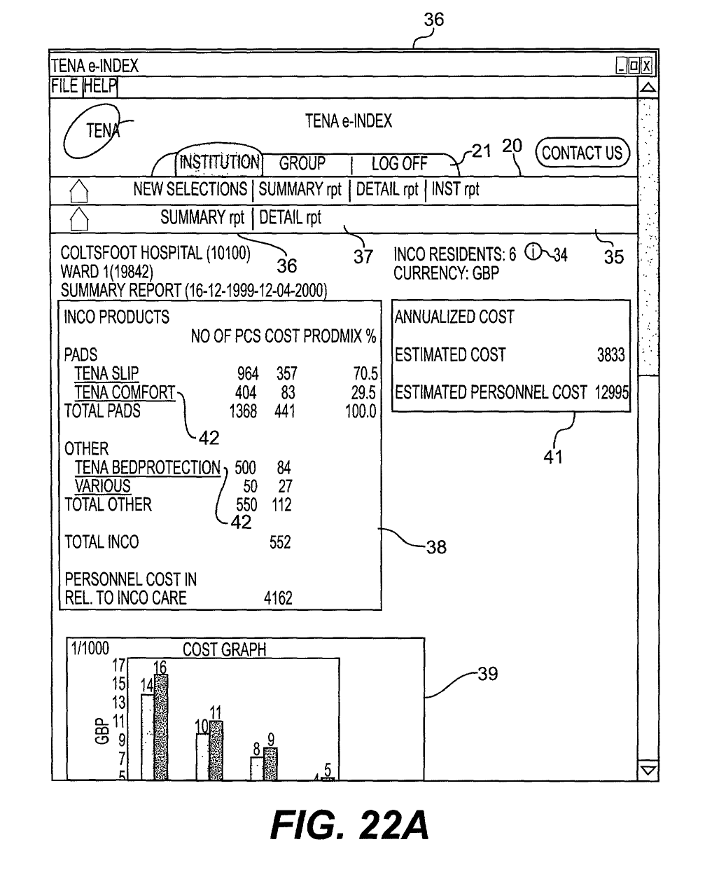

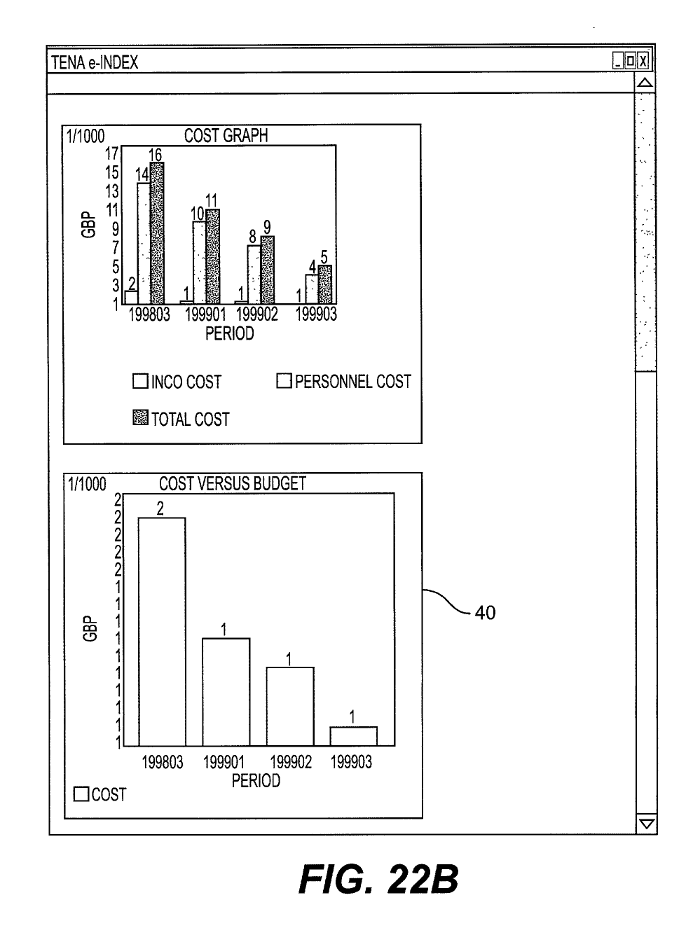

FIG. 22 illustrates a Detail Ward Report GUI 36. The Detail Ward report GUI 36 includes the toolbar 20 and a secondary toolbar 35. The secondary toolbar 35 includes reference to the Summary Ward Report GUI 36 and a Detail Ward Report GUI 37. The highlighted or active indication on the toolbar 35 indicates the active report.

The Summary Ward Report 36 includes various windows specific to the chosen ward within the chosen institution. As is seen in the header of the Summary Ward Report 36, the institution, specific ward, and period pertaining to the information listed on the report are shown. The windows included in the summary ward report 36 are an incontinence products window 38, a cost graph 39, a cost versus budget graph 40, and an annualized cost window 41. Specific links 42 of the incontinence products window 38 provide direct access to the Detail Ward Report GUI 37. The other elements of windows 38, 39, 40 and 41 will not be discussed in detail as their contents are self explanatory by viewing in detail FIG. 22. A Ward Information icon 43 is also included on the Summary Ward Report GUI 36. The Information Ward Icon 43 when chosen displays a superimposed window similar to that shown in FIG. 17, reporting the number of residents using incontinence products and the number of beds in the chosen ward.

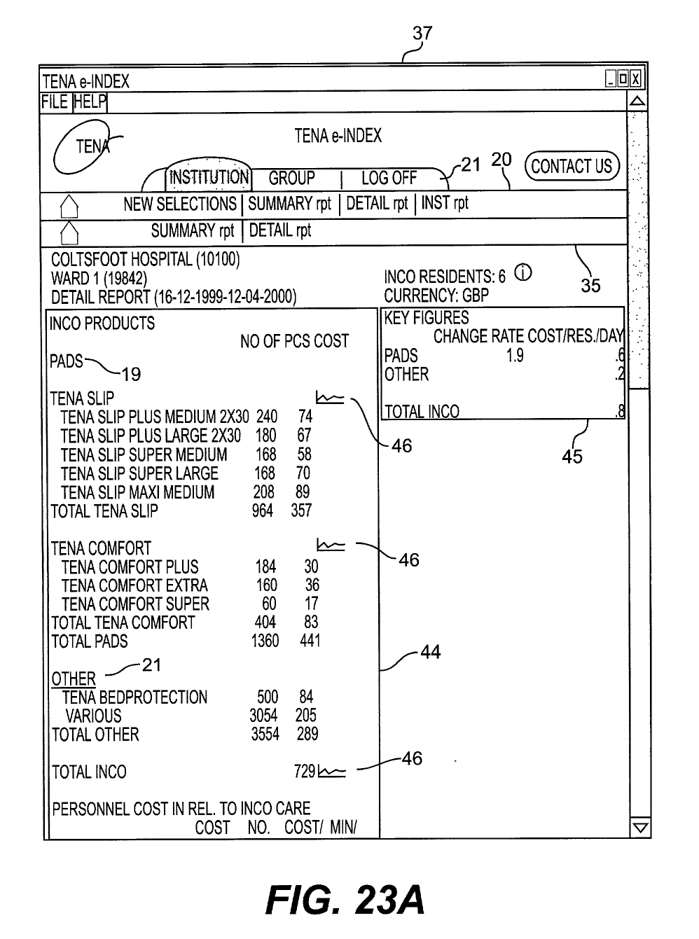

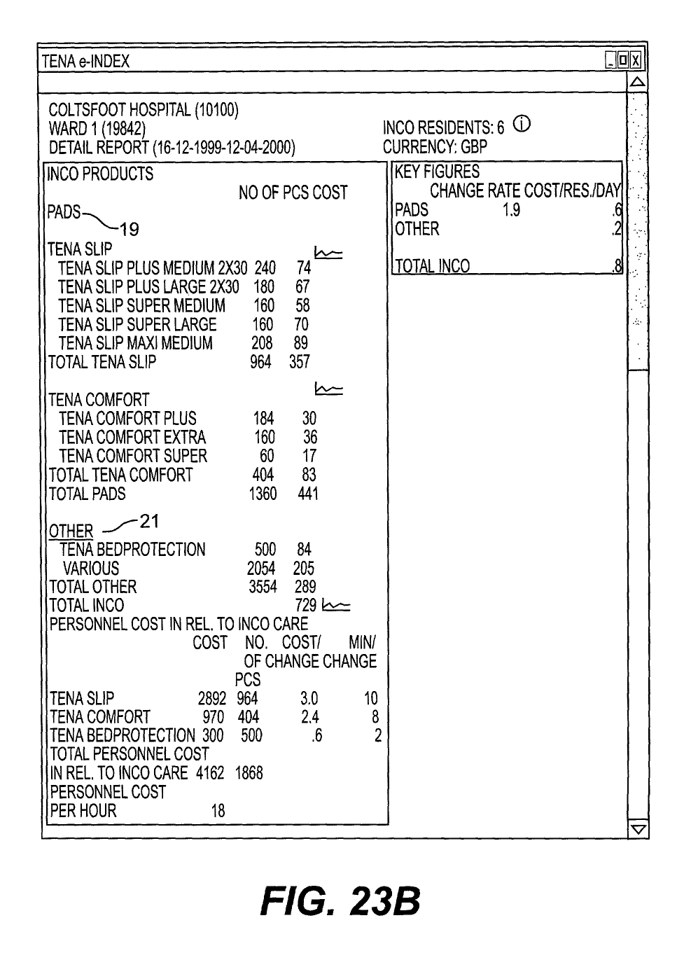

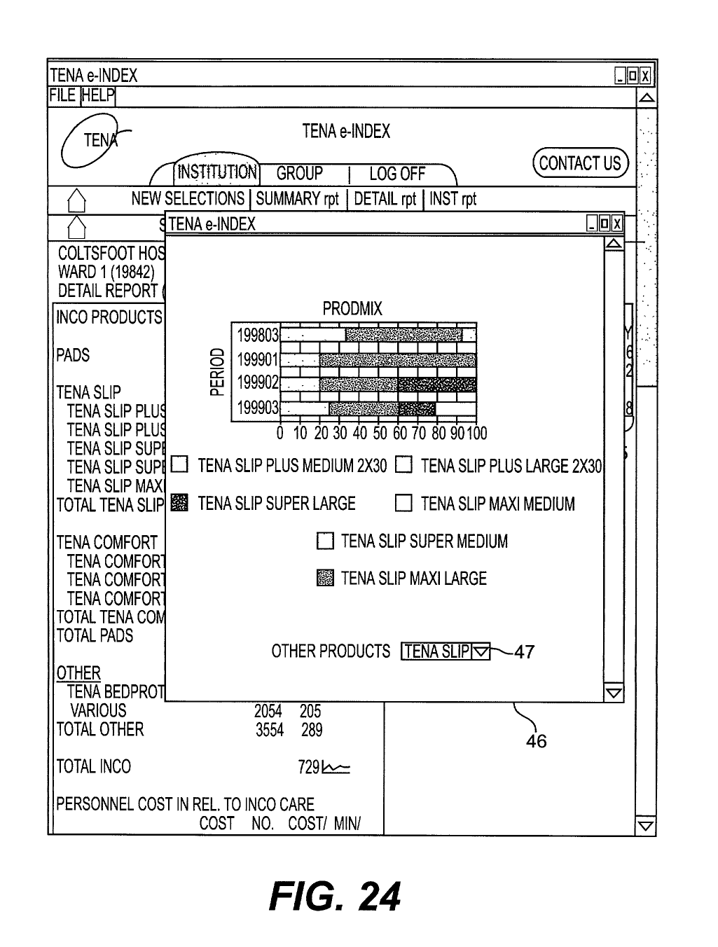

FIG. 23 illustrates the Detail Ward Report GUI 37. The detail ward report GUI 37 includes the toolbar 20 and the additional toolbar 35. The Detail Ward Report GUI 37 also includes information pertaining to the selected institution, ward, and time period for which the data displayed on the report pertains. The Detail Ward Report GUI 37 includes two specific windows. The windows are an incontinence products window 44 and a keyfigures window 45. The incontinence products window 44 includes detailed information related to the pads 19 and other 21. The incontinence products window 44 in addition includes totals related to incontinence products and personal costs in relation to incontinence care. The information provided in incontinence products window 44 is similar to the incontinence products window 28 shown in FIG. 19, yet the information provided in the incontinence products window 44 relates only to the specific ward chosen. The incontinence products window 44 also includes graph links 46. These graph links 46 may be selected to display specific information related to the incontinence products used within the chosen ward. An example of such a graph is shown in FIG. 24, which will be discussed hereinafter. The keyfigures window 45 includes specific information related to a change rate and cost per resident each day for the products used in the chosen ward. See FIG. 23 for the specifics of keyfigures window 45.

FIG. 24 illustrates a superimposed window containing a graph. The graph 46 is selectable using the graph links 46 contained in the Detail Ward Report GUI 37. The graph 46 shown in FIG. 5 relates to a specific type of pad used in the chosen ward. However, additional graphs may be displayed within these superimposed windows 46 using drop down menu 47.

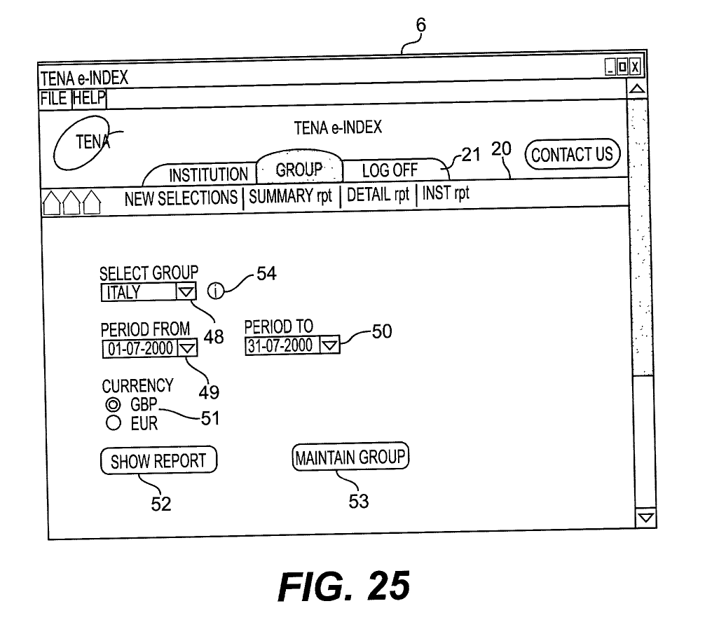

FIG. 25 illustrates a Group GUI according to the present invention. The Group GUI 6 includes the prior discussed toolbar 20 and tab box. In addition, the Group GUI 6 includes a select group drop down menu 48, a period from drop down menu 49, a period to drop down menu 50, currency selections 51, a Show Report button 52, a Maintained Group 53, and an Information icon 54. The selected group drop down menu 48 allows the user to choose between specific predefined groups. These predefined groups contain specific institutions affiliated with each predefined group. The Information icon 54 allows the user to view the specific institutions in the displayed group within the select group drop down menu 48. In other words, actuation of the Information icon 54 will generate a superimposed window listing specific institutions associated with a selected group. The period from drop down menu 49 allows the user to select a starting date delimiting the earliest possible data shown on a report displayed after actuating the Show Report button 52. The period to drop down menu 50 allows the user to delimit the outer boundaries of the data shown on a report generated by selecting the Show Report button 52. The currency selection menu 51 allows the user to select between specific currencies. In the figure, either Pounds or Euros may be chosen. However, other currency types may also be included and are fully embraced by the spirit of the present invention. The Maintain Group button 53 allows the user to add to, delete from, and/or create groups selectable within the selected group drop down menu 48.

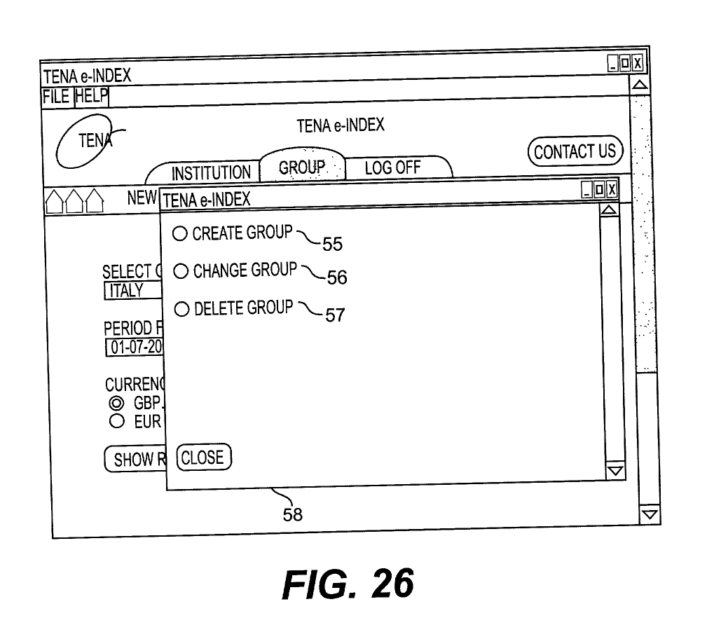

FIG. 26 illustrates a Maintained Group window. The Maintained Group window 58 is displayed upon actuation of the Maintained Group button 53 (FIG. 25). The Maintained Group window 58 includes several selectable items; in particular, a create group selection 55, a change group selection 56, and a delete group selection 57.

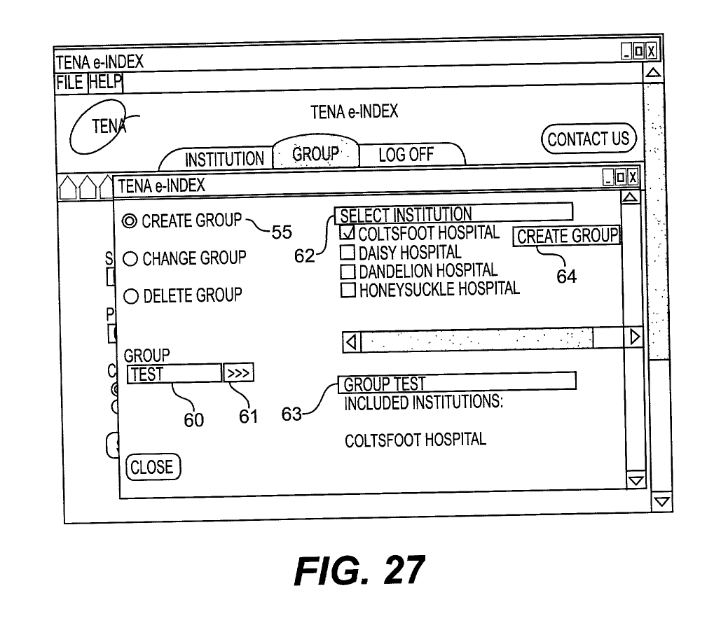

FIG. 27 illustrates a create group window 59. As is seen in the figure, the create group selection 55 has been selected by the user. This is evidenced by the darkening of the circle directly adjacent to the create group selection 55. The create group window 59 includes a group field 60. The group field 60 allows the user to enter a specific group name. The group name may contain a combination of alphanumeric characters, or the like. Actuation of an arrow box 61 brings up a selection field 62. The selection field 62 includes specific institutions, which may be added to the group entered in the group field 60. In the window shown in FIG. 27, four hospitals may be chosen from. However, additional hospitals may also be listed under the select institution listing 62. After choosing the desired hospitals for inclusion in the group entered in group field 60, a create group button 64 is actuated. Upon actuation of the create group button 64, a group display field 63 is shown. The group display field 63 includes the alphanumeric group entered in the group field 60 along with the institutions selected in select institution field 62. The group created within the create group 59 will now be selectable from the select group field 48 of the Group GUI 6 (FIG. 25).

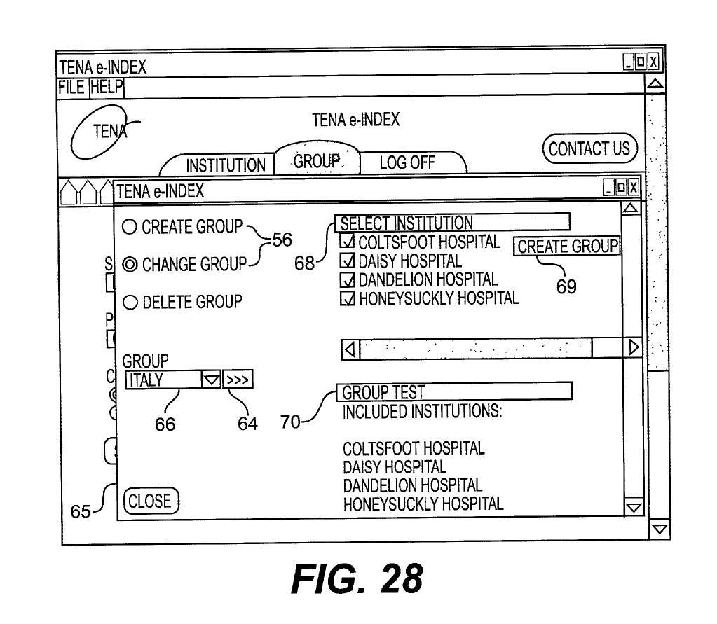

FIG. 28 illustrates a change group window. The change group window 65 is displayed once the change group selection 56 is chosen. The change group window 65 includes a group selection drop down menu 66. The group selection drop down menu 66 includes all the groups currently contained within a group database (not shown). Once a group is selected from the group drop down menu 66, a user may actuate an arrow button 67. The arrow button 67 displays a select institution section 68. The select institution section 68 includes all the hospitals included within the group selected from the group drop down menu 66. In addition, any additional groups which are not a part of the group selected in the group drop down menu 66 are also displayed in the select institution section 68. At this point, the user may select any institution(s) which must be added to the selected group. Alternatively, the user may also remove specific institutions from the selected group. Once additions and/or deletions have been made, the user may select the change group button 69 to initiate the change. The changes made to the selected group are shown in a group section 70. The group section 70 displays the group name along with the institutions. In this case, hospitals, which are part of the selected group.

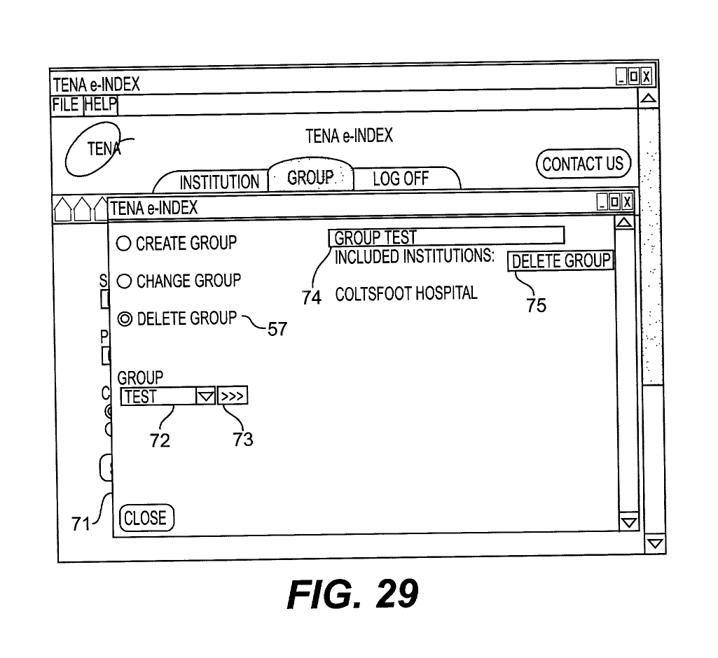

FIG. 29 illustrates a delete group window. The delete group window 71 is displayed upon selection of the delete group selection 57. The delete group window 71 contains a group drop down menu 72, an arrow selection button 73, a group section 74 and a delete group button 75. The user may select a specific group from the group drop down menu 72. Upon selection of a desired group, the user may actuate the arrow button 73 in order to display the group section 74. The group section 74 includes information pertaining to the selected group; in particular, the specific institutions associated with the selected group. The selected group may be deleted using the delete group button 75.

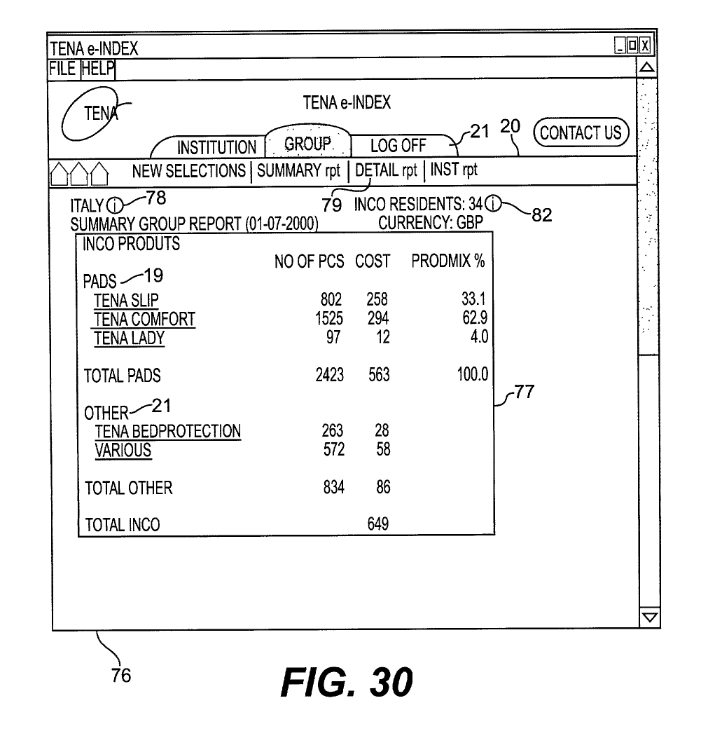

FIG. 30 illustrates a Summary Group Report GUI. The Summary Group Report GUI 76 is displayed after actuation of the Show Report button 52 (FIG. 25). The Summary Group Report GUI 76 includes information pertaining to the specific group chosen, a total number of incontinence residents, the chosen start and end dates, the chosen currency, and an incontinence products window 77. The incontinence products window 77 includes information pertaining to pads 19 and other 21. The products listed are links. The links allow the user to directly access a Detail Group Report GUI 79. The Group GUI 76 also includes an Information icon 78.

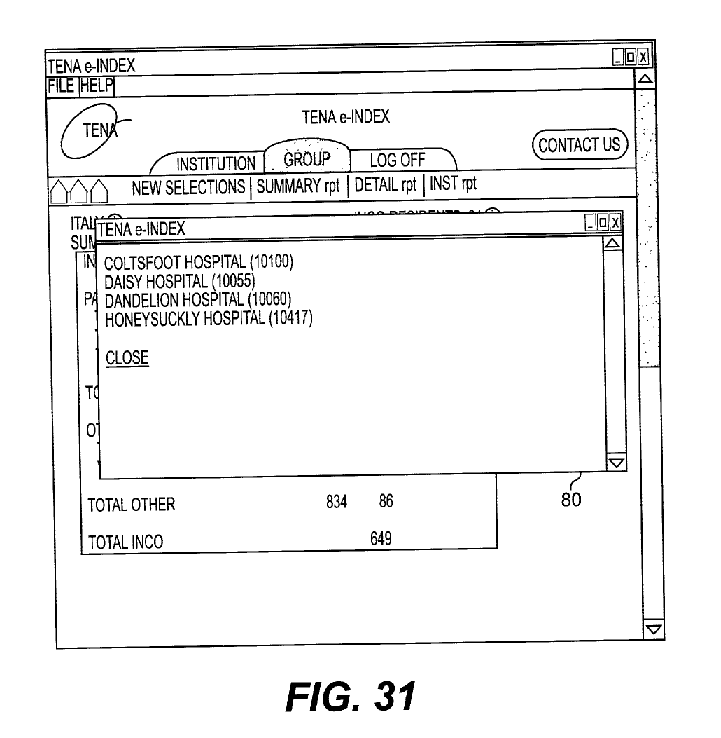

FIG. 31 illustrates a superimposed window relating to the Group GUI illustrated in FIG. 30. The superimposed window 80 is obtained upon actuation of the Information icon 78 (FIG. 30). The superimposed window 80 includes each of the institutions included in the selected group. In this case, the superimposed window 80 lists the hospitals affiliated with group Italy.

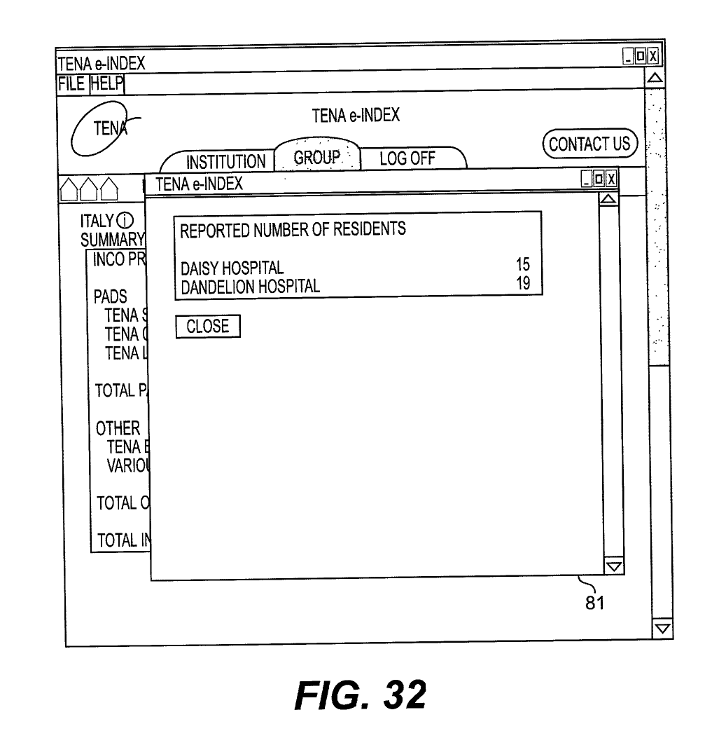

FIG. 32 illustrates a superimposed window that may be accessed using an Information icon illustrated in FIG. 30. An incontinence residents window 81 is displayed once a incontinence residents information icon 82 is actuated from the group GUI 76. The window 81 includes information pertaining to the number of residents in each of the hospitals within the selected group. In particular, only those hospitals containing incontinent residents are shown within the window 81.

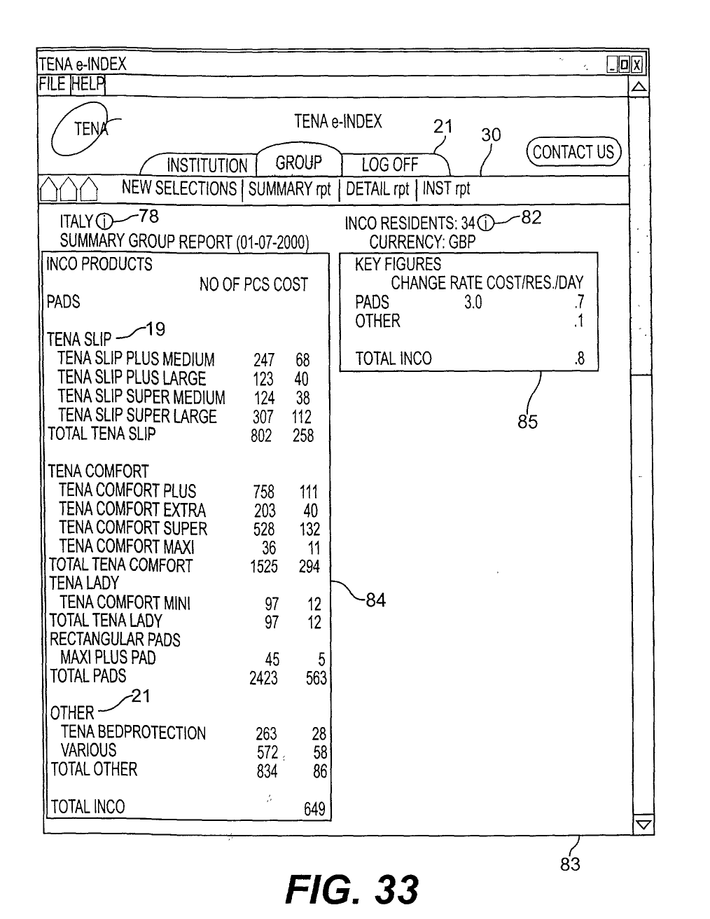

FIG. 33 illustrates a Detail Group Report GUI. The Detail Group Report GUI 83 includes the toolbar 20. Similarly, the Detail Group Report GUI 83 includes information pertaining to the selected group, the total number of incontinence residents, the chosen currency and the specific data period chosen. In addition, the Detail Group Report GUI 83 includes an incontinence products window 84 and a keyfigures window 85. The incontinence products window 84 includes information pertaining to pads 19 and other 21. However, the incontinence products window 84 lists specific products under the pads 19 and the other section 21. Similar to the Summary Group Report GUI 76, the Detail Group Report GUI 83 also includes Information icons 78 and 82. The specifics related to the Information icons 78 and 82 was discussed heretofore.

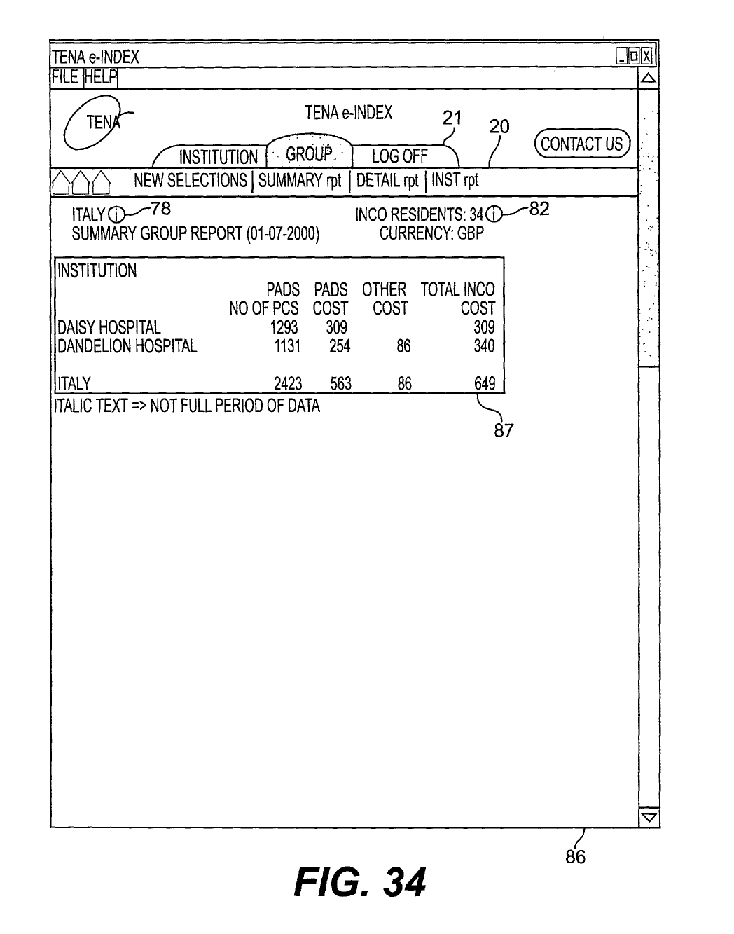

FIG. 34 illustrates an Inst group report. The Inst group report 86 GUI includes information pertaining to specific institutions affiliated with the chosen group. Moreover, the Inst Group Report GUI 86 includes the toolbar 20 and the tab box. Moreover, the GUI 86 includes information pertaining to the selected group, the total number of incontinence residents, the report period, and the selected currency. Information icons 78 and 82 are also selectable from the Inst Group Report GUI 86. An institution window 87 is part of the Inst Group Report GUI 86. The institution window 87 includes information pertaining to specific institutions of the chosen group. In particular, the listed institutions 88 are those which use/used incontinence products in caring for specific residents. The listed institutions 88 are linked to their respective detail report GUI's. In particular, actuation of either of institutions 88 will bring up a superimposed window containing a Detail Report GUI specific to the selected institution.

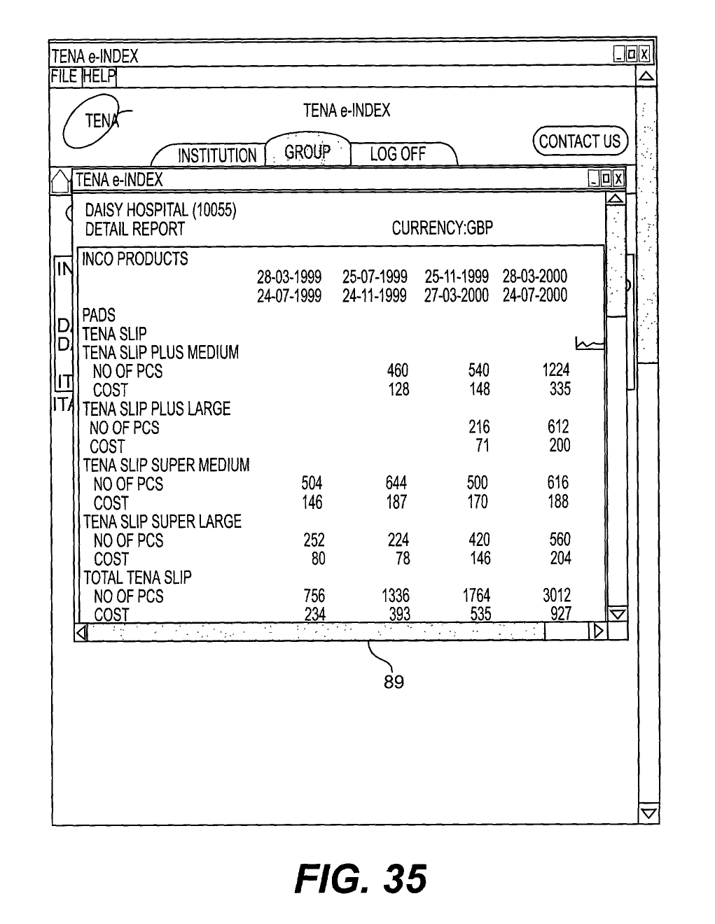

FIG. 35. illustrates the Detail Report GUI as a superimposed window. The superimposed window 89, including the Detail Report GUI, is obtainable using the institution links 88 (FIG. 34). The specific window 89 shown in FIG. 36 relates to Daisy hospital. In other words, the window 89 is displayed once the link 88 (Daisy hospital) is selected from the Inst Group Report GUI 86.

Data displayed and accessed using the various flow charts and screens illustrated in the figures is stored in a conventional database system. Alternatively, the data may be stored in a plurality of conventional database systems. As another alternative, the data displayed and accessed may originate from a database(s) distant from the GUI environment of the present invention. In such a case, communication between the database(s) and the GUI environment is facilitated using wireline and/or wireless communication medium. However, other communication medium may also be used, and such are fully embraced by the present invention.

The benefits to both the consumer and the manufacturer as a result of the present invention are numerous. On the consumer side, the present invention encourages an individual approach to incontinence management, toilet training and continence promotion programs. Moreover, the present invention facilitates the follow up of individual incontinence care. Specifically, based upon costs analysis, it may be possible to regulate individual incontinence care. Finally, the present invention helps to ensure incontinent patients are assessed correctly and that products are selected individually for each patient's specific needs.

With regard to manufacturer, the benefits as a result of the present invention are equally impressive. Foremost, using the present invention, the manufacturer is capable of analyzing a consumer's use of incontinence products, thereby tailoring a specific manufacturing cycle of particular types of incontinence products. The ability to tailor a specific manufacturing cycle to particular incontinence products reduces manufacturing costs while maintaining customer loyalty. Additionally, the ability to follow care procedures of incontinence product customers increases the manufacture's understanding of the customers' needs. At the same time, the ability to follow customers' use of incontinence products may increase awareness of potential competitors entering into the product arena. Furthermore, the present invention creates a business environment necessary to foster a long-term relationship between the manufacturer and the customer.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An data displaying interface, the interface comprising:
a page including;
a field for selecting a desired institution,
a field for selecting a desired period, and
a button for displaying one of a plurality of reports containing associated information pertaining to a selected institution and a selected period.

2. The data displaying interface of claim 1, wherein the page further comprises means for selecting one or more periods for display on one of the plurality of reports.

3. The data displaying interface of claim 1, wherein said first page further comprises means for selecting a currency type used on one of the plurality of reports.

4. The data displaying interface of claim 1, further comprising:
a subsequent page obtainable by way of actuation of said button, a content of said subsequent page being chosen from the plurality of reports, wherein the content is determined based upon a last displayed report of the plurality of reports.

5. The data displaying interface of claim 4, wherein the content of said subsequent page is a summary report, the summary report includes detailed information pertaining to products used in the selected institution over the selected period.

6. The data displaying interface of claim 5, wherein the summary report further includes a graph pertaining to costs associated with the products used.

7. The data displaying interface of claim 5, wherein the summary report further includes a graph pertaining to costs versus budget.

8. A method for displaying data, the method comprising the steps of:
generating a graphical user interface having a user selectable field pertaining to specific institutions, another user selectable field pertaining to specific time periods, means for selecting a number of periods, means for selecting a currency type, and a button; and
generating a subsequent graphical user interface upon actuation of the button, the subsequent graphical user interface being a report chosen from a plurality of predefined reports, wherein the report contains information relating to a selected institution and a specific time period.

9. The method according to claim 8, wherein the step of generating chooses the report from the plurality of predefined reports including at least a summary report, a detail report and a ward report.

10. The method according to claim 9, wherein the summary report includes information relating to major product groups used in the selected institution and over a selected number of periods.

11. The method according to claim 10, wherein the major product groups are each comprised of specific incontinence products related to a respective one of the major product groups.

12. The method according to claim 9, wherein the detailed report includes information relating to specific products of major product groups, the specific products each being an incontinence product.

13. A method for providing institutional specific information, the method comprising the steps of:
providing a graphical user interface accessible using required login information;
generating one of a plurality of reports based upon user selected institutional information and user selected periods of time; and
displaying on any one of the plurality of reports specific information relating to incontinence products used in the user selected institutional information and during the user selected periods of time.

14. The method according to claim 13, wherein the step of generating, the user selected institutional information is a specific user selected hospital or a group of hospitals previously grouped together.

15. The method according to claim 13, wherein the step of displaying, the one of the plurality of reports is selected from a summary report, a detail report and a ward report.

16. A product cost control method, comprising the steps of:
storing data representative of product use;
creating a graphical user interface accessible by at least one user, the graphical user interface including access to a plurality of reports containing information based upon the data;
providing an interface accessible from at least one of the plurality of reports, the interface containing administrator analysis information pertaining to the data.

17. The method according to claim 16, wherein the step of storing stores data related to incontinence products.

18. The method according to claim 17, wherein the step of providing provides analysis information relating to use of incontinence products over a specific period of time.

19. The data displaying interface of claim 1, wherein the associated information includes information relating to incontinence products.
